(19) United States
(12) Patent Application Publication
(10) Pub. No.: US 2024/0408878 A1
(43) Pub. Date: Dec. 12, 2024

(54) LIQUID EJECTING SYSTEM, LIQUID COLLECTION CONTAINER, AND LIQUID COLLECTION METHOD

(71) Applicant: SEIKO EPSON CORPORATION, Tokyo (JP)

(72) Inventors: Yohei ONUMA, Shiojiri-shi (JP); Shoma KUDO, Shiojiri-shi (JP)

(73) Assignee: SEIKO EPSON CORPORATION, Tokyo (JP)

(21) Appl. No.: 18/737,617

(22) Filed: Jun. 7, 2024

(30) Foreign Application Priority Data
Jun. 9, 2023 (JP) 2023-095778

(51) Int. Cl. B41J 2/17; B41J 2/175

(52) U.S. Cl. CPC B41J 2/1728; B41J 2/17513

(57) ABSTRACT

A liquid ejecting system includes a liquid ejecting apparatus provided with an ejection head that ejects liquid and a liquid container capable of storing liquid supplied to the ejection head, and a liquid collection container. The liquid container includes a liquid storage portion capable of storing liquid, a liquid pouring portion that pours liquid into the liquid storage portion, a liquid supply portion that supplies liquid to the ejection head, and a liquid discharge portion that discharges the liquid stored in the liquid storage portion to the outside. The liquid collection container includes a collection coupling portion capable of coupling with the liquid discharge portion, and a collection container portion that stores liquid collected from the liquid container through coupling between the liquid discharge portion and the collection coupling portion.

The present application is based on, and claims priority from JP Application Serial Number 2023-095778, filed Jun. 9, 2023, the disclosure of which is hereby incorporated by reference herein in its entirety.

### BACKGROUND

### 1. Technical Field

The present disclosure relates to a liquid ejecting system including a liquid ejecting apparatus equipped with an ejection head that ejects liquid, a liquid collection container, and a liquid collection method.

### 2. Related Art

For example, as an example of a liquid ejecting apparatus, JP-A-2018-69717 discloses an ink jet printer including an ejection head that ejects liquid such as ink toward a medium such as paper.

This liquid ejecting apparatus includes an ink tank as an example of a liquid container storing liquid supplied to the ejection head.

Moreover, a cartridge-type liquid ejecting apparatus to which ink cartridges can be mounted detachably is known. In the case of the cartridge type, when the ink runs out, the whole ink cartridge is replaced. On the other hand, a liquid container such as an ink tank is basically assembled while being fixed to a casing with a fixing portion such as screws. When ink runs out, the user couples an ink bottle to an ink pouring passage portion of the liquid container to refill the liquid container with liquid from the ink bottle.

Incidentally, when disposing of a liquid ejecting apparatus, even if liquid such as ink remains in the ink cartridge, if the apparatus is a cartridge type, the apparatus can be disposed of after removing the ink cartridge. On the other hand, in the case of a liquid container such as an ink tank, the liquid ejecting apparatus is often disposed of with the liquid container fixed to the casing. However, when liquid such as ink remains in the liquid container at the time of disposal of the liquid ejecting apparatus, if the liquid ejecting apparatus is tilted during the disposal, the liquid may spill from the liquid container due to a loose or missing cap.

For this reason, when disposing of a tank-type liquid ejecting apparatus, the user may dispose of the liquid ejecting apparatus after collecting the liquid in the liquid container. This is because when disposing of the liquid ejecting apparatus, liquid such as residual ink in the liquid container may be left unprocessed and become a cause of environmental contamination.

However, in a liquid ejecting apparatus including a liquid-refillable liquid container, the liquid container is difficult to remove from the casing. Specifically, the liquid container is fixed to a sheet metal or the like forming the casing of the liquid ejecting apparatus by a fixing portion such as screws. With this structure, the liquid container is fixed firmly so as not to be affected by external impact during transport, for example. Hence, the liquid ejecting apparatus is disposed of with the liquid container assembled thereto. As described above, the liquid-refillable liquid container does not consider a configuration of discharging or collecting residual liquid in the liquid container when disposing of the liquid ejecting apparatus.

For example, in order to discharge or collect the liquid in the liquid container, it is necessary to disconnect the coupling between a liquid supply portion of the liquid container and a supply passage such as a tube, and remove the liquid from the liquid supply portion or from a filler port for liquid refill. Since the liquid supply portion and the filler port do not have a structure considering removal of the liquid, the liquid may spill during the removal or liquid such as ink may attach to the fingers and stain them. Specifically, the liquid supply portion that supplies liquid such as ink from the liquid container to an ejection head has a structure in which a tube is press-fitted and is not easily removable or insertable. Hence, when the tube is removed from the liquid supply portion, the ink in the liquid container may spill to the outside from the supply port of the liquid supply portion. Therefore, there is a need for a liquid ejecting apparatus that enables easy discharge and collection of residual liquid in a liquid container when disposing of the liquid ejecting apparatus.

### SUMMARY

A liquid ejecting system for solving the above problem includes a liquid ejecting apparatus provided with an ejection head that ejects liquid and a liquid container capable of storing liquid supplied to the ejection head, and a liquid collection container, in which: the liquid container includes a liquid storage portion capable of storing liquid, a liquid pouring portion that pours liquid into the liquid storage portion, a liquid supply portion that supplies liquid to the ejection head, and a liquid discharge portion that discharges the liquid stored in the liquid storage portion to the outside; and the liquid collection container includes a collection coupling portion capable of coupling with the liquid discharge portion, and a collection container portion that stores liquid collected from the liquid container through coupling between the liquid discharge portion and the collection coupling portion.

A liquid collection container for solving the above problem includes: a collection coupling portion capable of coupling with the liquid discharge portion of the liquid container; a collection container portion that stores liquid collected from the liquid container through the collection coupling portion coupled to the liquid discharge portion; and an atmospheric connection portion that connects the inside of the collection container portion to the atmosphere.

A liquid collection method of collecting liquid in the liquid container provided in the liquid ejecting apparatus in the liquid ejecting system for solving the above problem, the method including: coupling the liquid discharge portion of the liquid container and the collection coupling portion of the liquid collection container to each other; and moving and collecting the liquid in the liquid container into the liquid collection container by hydraulic head pressure.

### BRIEF DESCRIPTION OF THE DRAWINGS

FIG. 1 is a perspective view illustrating a liquid ejecting apparatus of a first embodiment.

FIG. 2 is a perspective view illustrating the liquid ejecting apparatus when a liquid container is refilled with liquid.

FIG. 3 is a schematic cross-sectional view illustrating an internal configuration of the liquid ejecting apparatus.

FIG. 4 is a schematic perspective view illustrating how a liquid container is removed from a storage portion.

FIG. 5 is a schematic front view illustrating the storage portion in which a plurality of liquid containers is accommodated.

FIG. 6 is a schematic plan view illustrating how a liquid container is removed from the storage portion.

FIG. 7 is a schematic cross-sectional view illustrating the liquid container.

FIG. 8 is a schematic side cross-sectional view illustrating a liquid container and an ejection head.

FIG. 9 is a schematic side cross-sectional view illustrating a process of moving a liquid container and releasing coupling with a passage.

FIG. 10 is a schematic side cross-sectional view illustrating a liquid container and a liquid collection container.

FIG. 11 is a schematic front view illustrating a liquid collection container.

FIG. 12 is a schematic side cross-sectional view illustrating how liquid is collected in a liquid collection container from a liquid container.

FIG. 13 is a schematic side cross-sectional view illustrating a liquid container and an ejection head of a second embodiment.

FIG. 14 is a schematic side cross-sectional view illustrating a process of moving a liquid container and releasing coupling with a passage.

FIG. 15 schematic side cross-sectional view illustrating a liquid container and a liquid collection container.

FIG. 16 is a schematic side cross-sectional view illustrating how liquid is collected in a liquid collection container from a liquid container.

FIG. 17 is a schematic front view illustrating a liquid container and a liquid collection container.

FIG. 18 is a schematic front view illustrating how liquid is collected in a liquid collection container from a liquid container.

FIG. 19 is a schematic front view illustrating a liquid container and a liquid collection container of a third embodiment.

FIG. 20 is a schematic front view illustrating how liquid is collected in a liquid collection container from a liquid container.

FIG. 21 is a schematic side cross-sectional view illustrating a liquid container and a liquid collection container.

FIG. 22 is a schematic side cross-sectional view illustrating how liquid is collected in a liquid collection container from a liquid container.

FIG. 23 is a schematic side cross-sectional view illustrating how liquid is returned from a liquid collection container to a liquid container.

FIG. 24 is a schematic side cross-sectional view illustrating a liquid container and a liquid collection container of a fourth embodiment.

FIG. 25 is a schematic side cross-sectional view illustrating how liquid is collected in a liquid collection container from a liquid container.

FIG. 26 is a schematic side cross-sectional view illustrating how liquid is returned from a liquid collection container to a liquid container.

FIG. 27 is a schematic side cross-sectional view illustrating of a liquid container and a liquid collection container of a fifth embodiment.

FIG. 28 is a schematic side cross-sectional view illustrating how liquid is collected in a liquid collection container from a liquid container.

FIG. 29 is a schematic side cross-sectional view illustrating how liquid is returned from a liquid collection container to a liquid container.

FIG. 30 is a schematic side cross-sectional view illustrating a liquid collection container including a sealing member of a modification.

FIG. 31 is a schematic side cross-sectional view illustrating a liquid collection container including a sealing member of a modification different from FIG. 30.

FIG. 32 is a schematic side cross-sectional view illustrating a liquid collection container including a sealing member of a modification different from FIG. 31.

FIG. 33 is a schematic side cross-sectional view illustrating a liquid collection container including a sealing member of a modification different from FIG. 32.

### DESCRIPTION OF EMBODIMENTS

### First Embodiment

Hereinafter, a first embodiment of a liquid ejecting apparatus including a liquid container will be described with reference to the drawings. Note that the liquid ejecting apparatus of the present embodiment is a multifunction peripheral, for example, and ejects liquid such as ink onto a medium such as paper to print (record) characters, images, and the like on the medium.

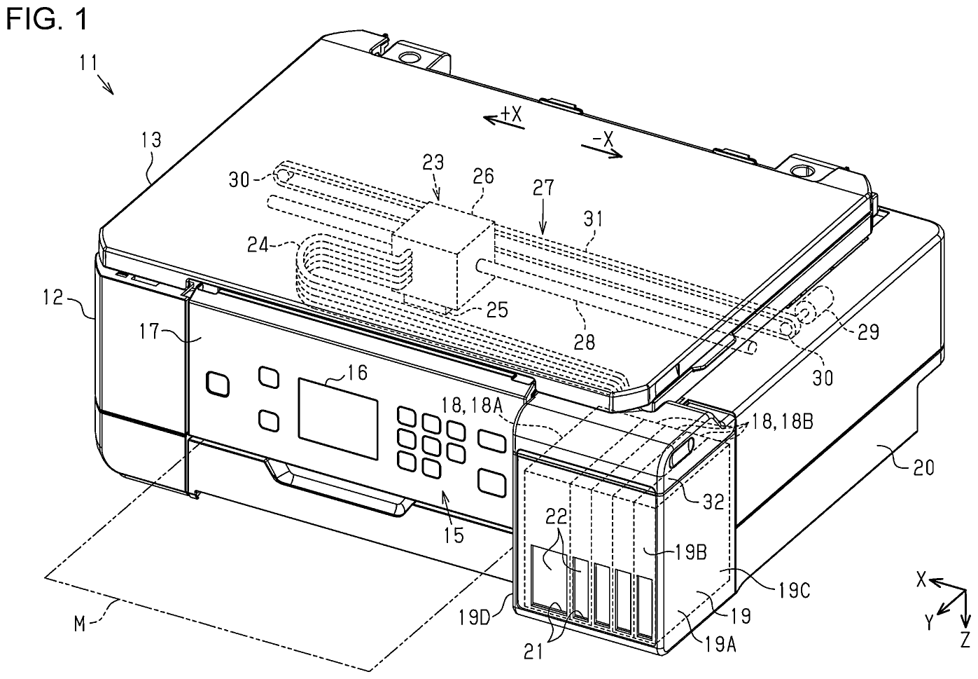

As illustrated in FIG. 1, a liquid ejecting apparatus 11 includes an ejection head 25 that ejects liquid and a liquid container 18 capable of storing liquid supplied to the ejection head 25. The liquid ejecting apparatus 11 which is also a multifunction peripheral includes an apparatus main body 12 and an image reading apparatus 13 in an upper part of the apparatus main body 12, and has a substantial rectangular parallelepiped shape as a whole.

FIG. 1 illustrates the liquid ejecting apparatus 11 placed on a horizontal plane, where the direction of gravity is a vertical direction Z and two directions along the horizontal plane are a width direction X and a transport direction Y. That is, the width direction X, the transport direction Y, and the vertical direction Z intersect (may be orthogonal to) one another. The transport direction Y is a direction in which a medium M is transported at a printing position facing the ejection head 25 described later. Moreover, in the transport direction Y, one end side may be referred to as the front side and the other end side opposite to the one end side may be referred to as the rear side. In the width direction X as viewed from the front side, one end side may be referred to as the right side and the other end side may be referred to as the left side.

### Configuration of Liquid Ejecting Apparatus 11

As illustrated in FIG. 1, an operation panel 17 is provided on a front surface of the liquid ejecting apparatus 11. The operation panel 17 has an operation portion 15 including buttons or the like for performing various operations and a display portion 16 displaying various types of information such as menus and operating statuses. Furthermore, a storage portion 19 is provided on the right side of the operation panel 17. At least one liquid container 18 is accommodated in the storage portion 19. A plurality of (five in the present embodiment) liquid containers 18 are accommodated in the storage portion 19 of the present embodiment. The storage portion 19 forms a part of a casing 20. In other words, the casing 20 includes the storage portion 19 capable of accommodating a plurality of liquid containers 18. The liquid container 18 is an ink-tank type, for example.

The storage portion 19 includes a substantially box-shaped storage portion main body 19A open toward the upper side and a cover 32. The cover 32 covers an upper opening of the storage portion main body 19A in an openable and closable state. The storage portion main body 19A includes a door body 19B located on the front side and having at least one (five in the present embodiment) window portion 21 for viewing, and a pair of left and right side plates 19C and 19D. The window portion 21 is provided for each liquid container 18. A viewing surface 22 on a front surface of the liquid container 18 is exposed in the window portion 21. The user views the remaining amount of liquid in the liquid container 18 through the viewing surface 22 exposed in the window portion 21. In the present embodiment, the door body 19B which is a plate-shaped part having the window portion 21 and forming a front plate portion of the storage portion main body 19A is attachable and detachable to and from the storage portion main body 19A.

As illustrated in FIG. 1, the plurality of liquid containers 18 accommodated in the storage portion 19 includes a first liquid container 18A and a second liquid container 18B capable of storing different amounts of ink, and is arranged side by side in the width direction X. The example illustrated in FIG. 1 includes one first liquid container 18A and four second liquid containers 18B. The one first liquid container 18A has a larger capacity than the second liquid container 18B and stores black ink, for example. The four second liquid containers 18B store different colored inks, for example. The plurality of liquid containers 18 stores, as different types of liquid, ink of colors such as cyan, magenta, yellow, and black. The liquid may be pigmented ink, or may be dye ink. Alternatively, the liquid may be a coating liquid or the like.

The first liquid container 18A and the second liquid container 18B have the same basic configuration except for different width dimensions due to the different capacities. Hence, when no particular distinction is made between the first liquid container 18A and the second liquid container 18B, they are referred to simply as “liquid container 18.”

In addition, the liquid ejecting apparatus 11 includes, inside the casing 20, a printing portion 23 that prints by attaching liquid such as ink onto the medium M, and a supply passage 24 formed of a tube or the like supplying the liquid in the liquid container 18 to the printing portion 23. The printing portion 23 of the present embodiment includes the ejection head 25 and a carriage 26 capable of moving back and forth along the width direction X (scanning direction) while holding the ejection head 25. The printing portion 23 prints on the medium M by ejecting liquid toward the medium M from the moving ejection head 25.

The liquid ejecting apparatus 11 of the present embodiment includes a plurality of liquid containers 18 supplying liquid to the ejection head 25. The plurality of liquid containers 18 are capable of storing the liquid supplied to the ejection head 25. The liquid ejecting apparatus 11 includes the ejection head 25 and the casing 20 accommodating the plurality of liquid containers 18. The liquid ejecting apparatus 11 also includes fixing portions 42 that fix the plurality of liquid containers 18 to the casing 20. That is, the plurality of liquid containers 18 is fixed to the casing 20 via the fixing portions 42.

The liquid ejecting apparatus 11 includes, in the casing 20, a scanning mechanism 27 that causes the printing portion 23 to move (scan). The scanning mechanism 27 has a guide shaft 28 that guides the carriage 26 so as to be movable in the width direction X, a carriage motor 29 which is a drive source, a pair of pulleys 30, and an endless timing belt 31 wound around the pair of pulleys 30. Of the pair of pulleys 30, one is fixed to an output shaft of the carriage motor 29. When the carriage motor 29 is driven forward, the printing portion 23 moves back and forth in the +X direction, and when the carriage motor 29 is driven in reverse, the printing portion 23 moves back and forth in the −X direction.

The casing 20 accommodates the liquid container 18, the supply passage 24, the ejection head 25, the carriage 26, the scanning mechanism 27, and the like. A plurality of supply passages 24 is provided individually corresponding to the liquid containers 18. That is, the plurality of liquid containers 18 supplies different colored liquids to the printing portion 23 through a plurality of supply passages 24.

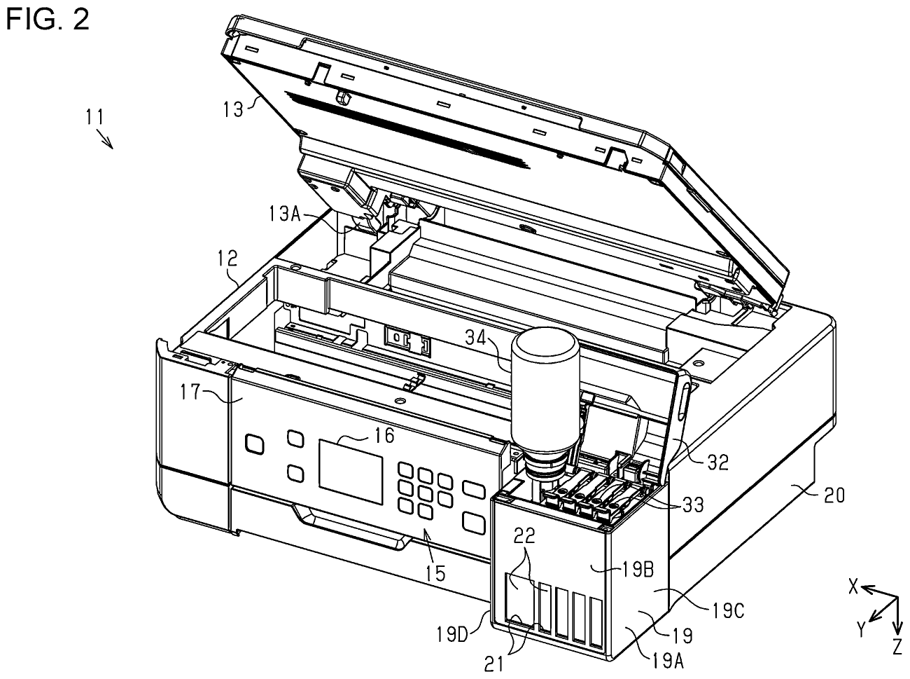

As illustrated in FIG. 2, the image reading apparatus 13 is openable and closable between a closed position illustrated in FIG. 1 and an open position illustrated in FIG. 2 with respect to the liquid ejecting apparatus 11 via a rotating mechanism 13A such as a hinge. When the image reading apparatus 13 is set in the open position, the cover 32 and a cap lever 33 attached to the liquid container 18 (see FIG. 1) are openable and closable. When refilling the liquid container 18 with liquid such as ink, as illustrated in FIG. 2, the image reading apparatus 13, the cover 32, and the cap lever 33 are set in the open position. A supply port of a liquid bottle 34 is coupled to a liquid filler port of the liquid container 18 with the liquid bottle 34 in an upside-down position and the supply port facing down. Note that while the cover 32 is configured to be openable and closable when the image reading apparatus 13 is in the open state, the cover 32 may be configured to be openable and closable on its own when the image reading apparatus 13 is in the closed state.

### Internal Configuration of Liquid Ejecting Apparatus 11

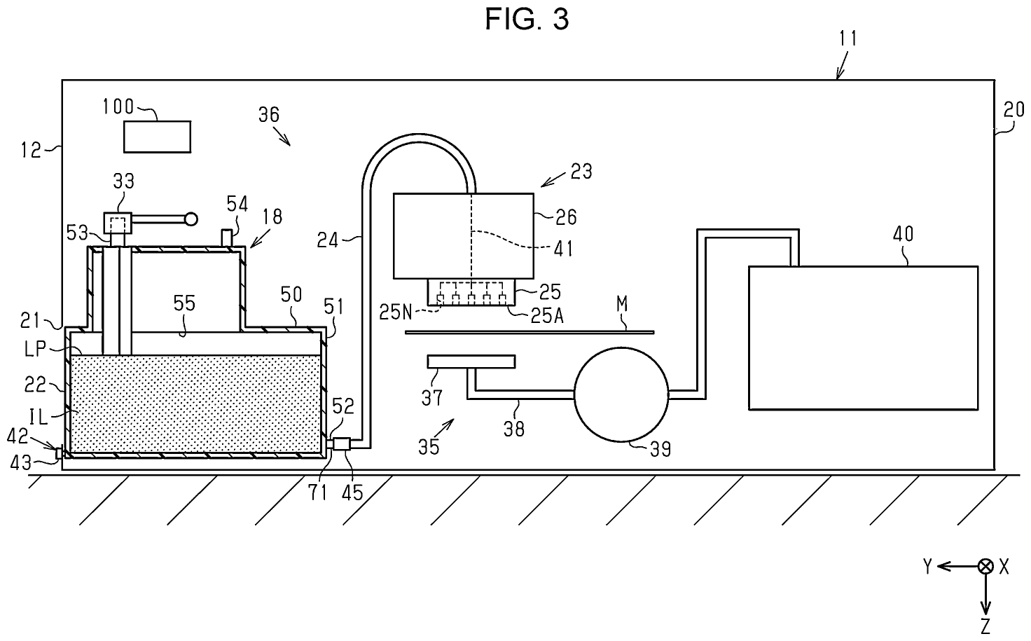

Next, an internal configuration of the liquid ejecting apparatus 11 will be described with reference to FIG. 3. As illustrated in FIG. 3, the ejection head 25 includes a nozzle forming surface 25A on which a nozzle 25N opens. In the example illustrated in FIG. 3, a plurality of nozzles 25N opens on the nozzle forming surface 25A. The ejection head 25 is capable of ejecting liquid from a plurality of nozzles 25N. For example, a plurality of nozzles 25N may be provided for each type (e.g., color) of liquid to be ejected.

The liquid ejecting apparatus 11 includes a maintenance device 35 that performs maintenance of the ejection head 25, and a liquid supply device 36 that supplies liquid to the ejection head 25 from the liquid container 18. The maintenance device 35 includes a cap 37 that can be raised and lowered with respect to the ejection head 25 in a standby position, and a discharge tube 38 coupled to the cap 37. The cap 37 is movable between a retracted position illustrated in FIG. 3 away from the ejection head 25 and a capping position (not illustrated) where the cap 37 comes into contact with the nozzle forming surface 25A of the ejection head 25. The cap 37 can receive liquid ejected or discharged from the nozzle 25N for maintenance.

When in the capping position, the cap 37 forms, with the nozzle forming surface 25A, a closed space connected to the nozzle 25N. The maintenance device 35 includes a suction pump 39 interposed in the middle of the discharge tube 38. The maintenance device 35 drives the suction pump 39 while capping the ejection head 25, and decompresses the closed space surrounded and formed by the cap 37 and the nozzle forming surface 25A. The decompression causes foreign matter such as air bubbles to be sucked out from the nozzle 25N of the ejection head 25 together with the liquid. The liquid discharged from the nozzle 25N by the cleaning is collected in a liquid waste storage portion 40 through the cap 37 and the discharge tube 38.

As illustrated in FIG. 3, while a plurality of liquid supply devices 36 is provided for the plurality of liquid containers 18, FIG. 3 illustrates one liquid supply device 36 including one liquid container 18. Since the plurality of liquid supply devices 36 basically has the same configuration, a configuration of one liquid supply device 36 will be described below.

As illustrated in FIG. 3, the liquid supply device 36 includes the liquid container 18 and the supply passage 24 that supplies liquid in the liquid container 18 to the ejection head 25. The supply passage 24 may be an elastically deformable tube, or may be formed inside a passage forming member made of a hard resin material. Alternatively, the supply passage 24 may include a part formed by adhering a film on a passage forming member in which a groove is formed.

An upstream end portion (one end portion) of the supply passage 24 is coupled to the liquid container 18. A downstream end portion (other end portion) of the supply passage 24 is coupled to an upstream end portion of a liquid passage 41 of the carriage 26. The liquid in the liquid container 18 is sent to the ejection head 25 through the supply passage 24 and the liquid passage 41.

The liquid container 18 includes a container main body 50. The container main body 50 is formed of a synthetic resin case. Moreover, the case forming the container main body 50 is made of transparent or semi-transparent resin. Hence, the liquid level of the liquid stored in a liquid compartment 55 can be viewed from the outside through the viewing surface 22 on a front surface of the container main body 50. The liquid container 18 is fixed to the liquid ejecting apparatus 11 with the fixing portion 42. For example, the fixing portions 42 are formed of screws 43 or the like that fix the liquid container 18 directly or via an attachment member (not illustrated) to a frame forming the casing 20. Incidentally, the container main body 50 may be formed such that a film is fixed on one surface of a storage case having a compartment recess portion recessed from a surface, and the liquid compartment 55 is surrounded by the film and the compartment recess portion.

As illustrated in FIG. 3, the liquid container 18 includes a liquid storage portion 51 capable of storing liquid, a liquid pouring portion 53 that pours liquid into the liquid storage portion 51, and a liquid supply portion 52 that supplies liquid to the ejection head 25.

Furthermore, the liquid container 18 includes a liquid discharge portion 71 that discharges liquid stored in the liquid storage portion 51 to the outside.

The liquid supply portion 52 is a part to which one end portion of the supply passage 24 supplying liquid to the ejection head 25 is directly or indirectly coupled. The liquid supply portion 52 supplies liquid in the liquid storage portion 51. The liquid supply portion 52 of the present embodiment is a part to which one end portion of the supply passage 24 supplying liquid to the ejection head 25 is directly coupled. The present embodiment is configured such that the liquid supply portion 52 also serves as the liquid discharge portion 71. A connection portion 45 is fixed to the upstream one end portion of the supply passage 24. The liquid supply portion 52 is coupled to the supply passage 24 via the connection with the connection portion 45.

As illustrated in FIG. 3, at least a part of the liquid container 18 is located lower than the ejection head 25. That is, the ejection head 25 is located higher than a liquid level LP in the liquid container 18 in the vertical direction Z. To be specific, an opening of the nozzle 25N is located higher than the position of the liquid level LP in the liquid container 18 at its maximum height. Note that the positional relationship of the ejection head 25 and the liquid container 18 in the vertical direction Z can be set arbitrarily as long as a liquid meniscus is formed in the nozzle 25N and liquid does not drip from the nozzle 25N.

The liquid ejecting apparatus 11 illustrated in FIG. 3 includes a controller 100 that controls the overall operation. The controller 100 controls the carriage motor 29 that moves the carriage 26 back and forth, a transport portion (not illustrated) that transports the medium M, an ejection operation of the ejection head 25, a cleaning operation of the maintenance device 35, and the like.

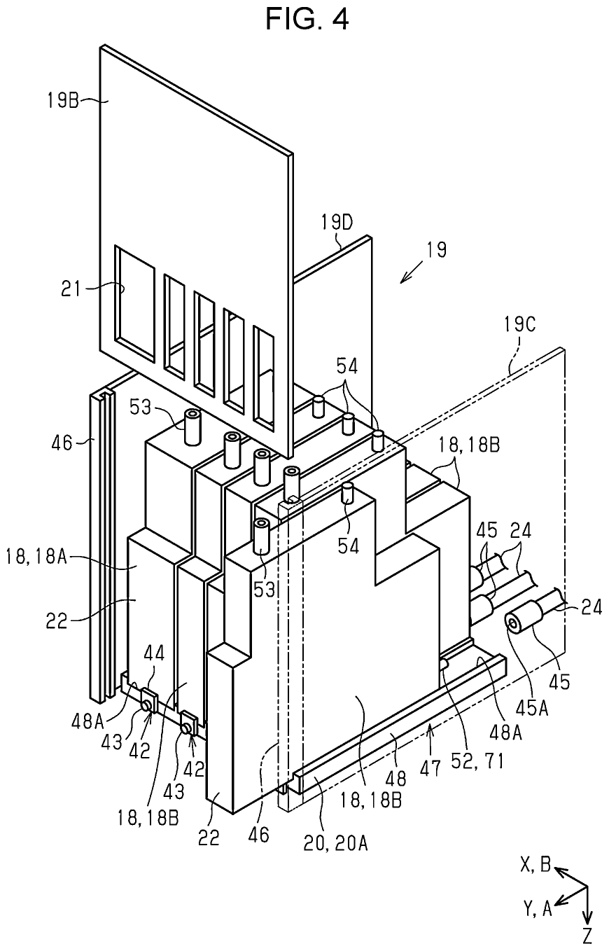

As illustrated in FIG. 4, in the storage portion 19, there is provided a separating mechanism 47 capable of separating the liquid container 18 from the casing 20 individually in a state where fixing of the liquid container 18 to the casing 20 by the fixing portions 42 is released. The separating mechanism 47 can separate the liquid container 18 from the casing 20 individually in a first direction A. The first direction A is a direction in which the liquid supply portion 52 can be separated from the one end portion of the supply passage 24.

The separating mechanism 47 includes a mounting portion 48 forming at least a part of a bottom plate 20A of the casing 20. An upper surface of the mounting portion 48 is a mounting surface on which the plurality of liquid containers 18 is mounted side by side in a second direction B intersecting the first direction A which is the separating direction. A guide portion 48A extending in the first direction A with a slightly larger width dimension than the width dimension of the liquid container 18 is provided in the mounting surface of the mounting portion 48. In the example illustrated in FIG. 4, the guide portion 48A is a slide groove recessed from the upper surface of the mounting portion 48. The slide groove is a guide groove extending along the first direction A. The guide groove is a groove that penetrates at least on the first direction A side. Note that the guide portion 48A is not limited to a guide groove such as the slide groove, and may be a rail that engages with a rail groove recessed from a bottom surface of the liquid container 18 and capable of guiding the liquid container 18 in the first direction A.

The fixing portions 42 are formed of the screws 43 and restriction members 44. The fixing portions 42 are fixed to a front surface of the mounting portion 48 while restricting movement of the liquid container 18 in the first direction A. Note that the fixing portions 42 may fix the liquid container 18 to the mounting portion 48 by engagement via the restriction members 44.

The storage portion 19 has the door body 19B. The door body 19B is movable between a shielding position covering the first direction A side of the plurality of liquid containers 18 and an open position not covering the first direction A side thereof with respect to the casing 20. The door body 19B has the window portion 21 that allows the user to view the remaining amount of liquid in the liquid container 18.

When the door body 19B is in the open position, the user can pull the liquid container 18 out of the storage portion 19 in the first direction A. The separating mechanism 47 has the guide portion 48A capable of guiding the liquid containers 18 individually in the first direction A. With the guide portion 48A, the user can move the liquid containers 18 individually in the first direction A. When the user moves the liquid container 18 in the first direction A, the liquid supply portion 52 is separated from the one end portion of the supply passage 24. That is, the coupling between the liquid supply portion 52 and a coupling port 45A of the connection portion 45 is disconnected.

### Configuration of Liquid Container 18

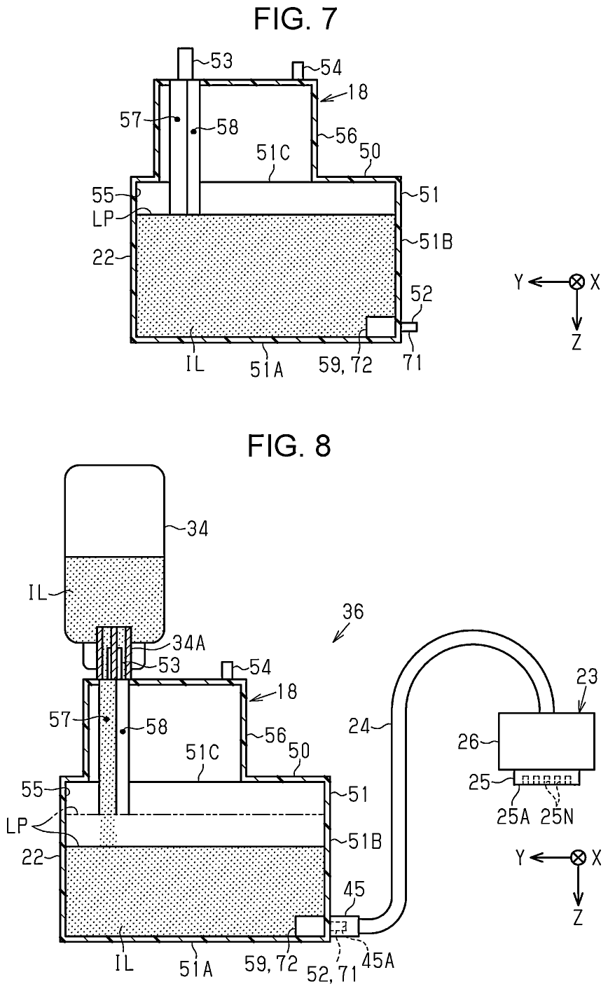

Next, a configuration of the liquid container 18 will be described with reference to FIG. 7. Note that the first liquid container 18A and the second liquid container 18B have different width dimensions due to the difference in capacity, but the basic configuration is the same. Hence, in the following description, the first liquid container 18A and the second liquid container 18B will be described as a liquid container 18 without making particular distinction between the two.

As illustrated in FIGS. 7 and 8, the container main body 50 has the liquid storage portion 51 having the liquid compartment 55, and a protruding portion 56 protruding from the upper side of the liquid storage portion 51. The container main body 50 has, as pipe-shaped parts protruding outward, the liquid supply portion 52, the liquid pouring portion 53, and an atmospheric connection portion 54. The liquid supply portion 52, the liquid pouring portion 53, and the atmospheric connection portion 54 are connected to the liquid compartment 55. A liquid IL is stored in the liquid compartment 55.

The liquid pouring portion 53 is used to pour liquid such as ink into the liquid compartment 55. The liquid pouring portion 53 and the liquid compartment 55 are coupled via a liquid passage 57 and an air passage 58. The liquid pouring portion 53 is connected to both of the liquid passage 57 and the air passage 58. Liquid compartment 55-side end portions (lower ends) of the liquid passage 57 and the air passage 58 are located at the highest liquid level.

The atmospheric connection portion 54 connects an air area above the liquid level LP in the liquid compartment 55 to the atmosphere. The container main body 50 has a partition wall portion 51C that separates the liquid storage portion 51 and the protruding portion 56 on the inside of the container main body 50. A connection path between the liquid compartment 55 and the atmospheric connection portion 54 partially includes thin meandering pores. Accordingly, the liquid compartment 55 is connected to the atmospheric connection portion 54 while moisture of the liquid stored in the liquid compartment 55 does not evaporate easily.

As illustrated in FIG. 8, when pouring liquid into the liquid container 18, a supply portion 34A is coupled to the liquid pouring portion 53 with the liquid bottle 34 in an upside-down position. The inside of the liquid bottle 34 coupled to the liquid pouring portion 53 is connected to the liquid compartment 55 through both of the liquid passage 57 and the air passage 58. Hence, the liquid in the liquid bottle 34 is poured into the liquid container 18 through the liquid passage 57 while the air in the liquid compartment 55 is sent into the liquid bottle 34 through the air passage 58. This gas-liquid exchange allows the liquid to be continuously poured into the liquid compartment 55 from the liquid bottle 34 until the liquid level LP reaches the lower end of the air passage 58. Then, when the liquid level LP reaches the lower end of the air passage 58, the gas-liquid exchange is no longer performed and the pouring of the liquid into the liquid compartment 55 from the liquid bottle 34 stops. Thus, when the liquid level LP reaches the highest liquid level, pouring of the liquid into the liquid container 18 is stopped. Note that when liquid is poured into the liquid container 18 from the liquid bottle 34, the air in the liquid compartment 55 is discharged from the atmospheric connection portion 54.

As illustrated in FIGS. 7 and 8, in the liquid container 18 of the first embodiment, the liquid supply portion 52 also serves as the liquid discharge portion 71. The liquid discharge portion 71 is arranged in a bottom surface 51A or a lower portion of a side surface 51B of the liquid storage portion 51. Hence, the liquid supply portion 52 also serving as the liquid discharge portion 71 is arranged in the bottom surface 51A or a lower portion of the side surface 51B of the liquid storage portion 51. Note that in the example illustrated in FIGS. 7 and 8, the liquid supply portion 52 also serving as the liquid discharge portion 71 is arranged in a lower portion of the side surface 51B of the liquid storage portion 51.

Here, a lower portion of the side surface 51B may be half the height of the highest liquid level in the liquid storage portion 51 or lower, for example. It goes without saying that if the liquid discharge portion 71 is located as low as possible in the liquid compartment 55, more liquid can be discharged using the hydraulic head pressure between the liquid level in the liquid storage portion 51 and a discharge port of the liquid discharge portion 71. However, a small amount of liquid left in the liquid storage portion 51 can also be discharged by tilting the liquid container 18. Hence, it is sufficient that the liquid discharge portion 71 is located at a height where it can discharge at least a part of the liquid using hydraulic head pressure when there is half or more liquid remaining in the liquid storage portion 51.

As illustrated in FIGS. 7 and 8, a bottom surface of the liquid compartment 55 is tilted such that its height is lower on the opposite side of the viewing surface 22 in the transport direction Y. Hence, the liquid in the liquid container 18 is easily supplied to the outside from the liquid supply portion 52 until the end. Note that the inside of the liquid compartment 55 may be partitioned into a plurality of compartments connected to each other by a plurality of ribs (not illustrated). In this case, when the liquid ejecting apparatus 11 is transported, for example, shaking of the liquid in the liquid compartment 55 is curbed, and air (bubbles) in the liquid due to bubbling caused by shaking or the like is curbed.

When the liquid supply portion 52 is connected (coupled) to the connection portion 45, the liquid supply portion 52 is coupled to the coupling port 45A of the connection portion 45. In the liquid container 18, the liquid supply portion 52 includes a first valve 59 capable of opening and closing a passage supplying liquid. In other words, in the first embodiment in which the liquid supply portion 52 also serves as the liquid discharge portion 71, the liquid discharge portion 71 has a second valve 72 capable of opening and closing a passage discharging liquid. Here, the liquid supply portion 52 is a part having a discharge port for supplying the liquid in the liquid container 18 to the ejection head 25. On the other hand, the liquid discharge portion 71 is a part having a discharge port for discharging the residual liquid in the liquid container 18 to the outside when disposing of the liquid ejecting apparatus 11, for example. The liquid supply portion 52 and the liquid discharge portion 71 both have the function of discharging the liquid in the liquid container 18, although the discharge destination is either the ejection head 25 or the outside. Hence, one unit can serve as both the liquid supply portion 52 and the liquid discharge portion 71.

The first valve 59 is in a closed-valve state in a non-coupled state illustrated in FIG. 7 where the liquid supply portion 52 is not coupled to the connection portion 45 fixed to the upstream end portion of the supply passage 24. On the other hand, the first valve 59 is in an open-valve state in a coupled state illustrated in FIG. 8 where the liquid supply portion 52 is coupled to the connection portion 45 of the supply passage 24. The first valve 59 is automatically switched between open and closed states depending on whether or not the liquid supply portion 52 and the connection portion 45 are coupled to each other.

The first valve 59 may be configured in the following manner, for example. The first valve 59 has a valve body (not illustrated) energized in a direction of advancing outward by an energizing member (not illustrated) while being advanceable and retractable in axial direction of the liquid supply portion 52, and a valve seat on which the energized valve body abuts (not illustrated). For example, when the connection portion 45 is coupled to the liquid supply portion 52, the valve body at the back of the liquid supply portion 52 is separated from the valve seat by a force received from the connection portion 45, whereby the first valve 59 is switched to the open-valve state from the closed-valve state. When the connection portion 45 is removed from the liquid supply portion 52, the valve body comes into contact with the valve seat by the energizing force of the energizing member, so that the first valve 59 is switched to the closed-valve state from the open-valve state. Hence, the connection portion 45 can be attached and detached to and from the liquid supply portion 52 while curbing liquid leakage.

Moreover, when disposing of the liquid ejecting apparatus 11, for example, the first valve 59 also functions as the second valve 72. The second valve 72 has a function of opening and closing the discharge passage of the liquid discharge portion 71 when discharging the liquid in the liquid container 18 to the outside other than the ejection head 25. The second valve 72 may have the following structure, for example. The second valve 72 has a valve body energized by an energizing member (not illustrated) in a direction of advancing outward while being advanceable and retractable in its axial direction, and a valve seat on which the energized valve body abuts. For example, when a collection coupling portion 62 of a liquid collection container 60 described later is coupled to the liquid discharge portion 71, the valve body is separated from the valve seat by a force received from the collection coupling portion 62, whereby the second valve 72 is switched to the open-valve state from the closed-valve state. Moreover, when the collection coupling portion 62 is removed from the liquid discharge portion 71, the valve body comes into contact with the valve seat by the energizing force of the energizing member, so that the second valve 72 is switched to the closed-valve state from the open-valve state. Hence, the collection coupling portion 62 can be attached and detached to and from the liquid discharge portion 71 while curbing liquid leakage.

### Configuration of Liquid Ejecting System

In the present embodiment, the liquid ejecting system is formed of the liquid ejecting apparatus 11 and the liquid collection container 60 (hereinafter also referred to simply as “collection container 60.”). The liquid ejecting apparatus 11 and the collection container 60 may be sold as a set, or the user may obtain the collection container 60 for a fee or free of charge at the stage of disposal of the liquid ejecting apparatus 11. Alternatively, a recessed portion may be provided in the casing 20 of the liquid ejecting apparatus 11, and the collection container 60 may be inserted into the recessed portion. An opening of the recessed portion may be covered with a cover. The cover may be removed to take the collection container 60 out of the recessed portion for use when disposing of the liquid ejecting apparatus 11.

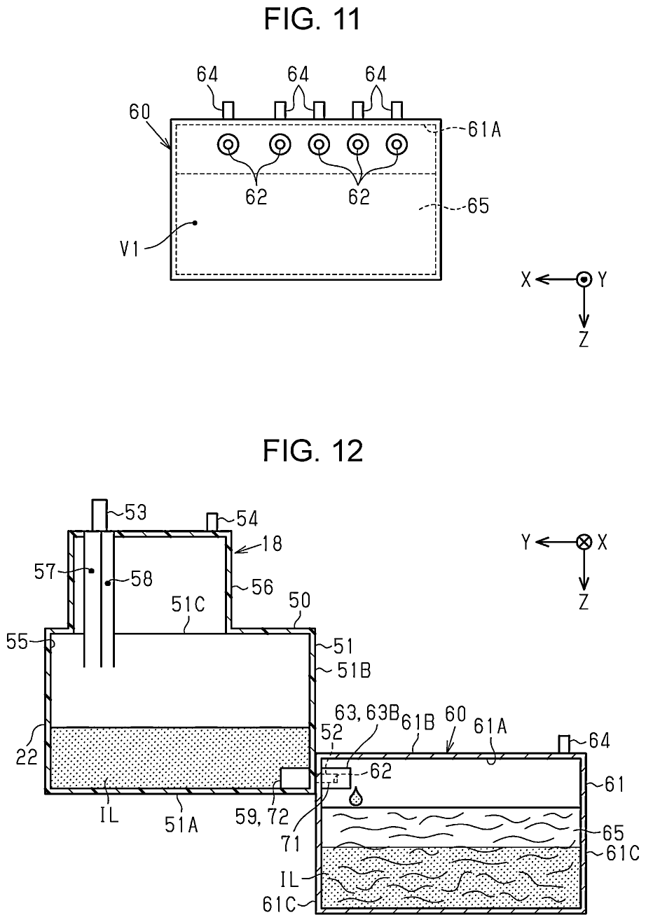

As illustrated in FIGS. 10 and 11, the collection container 60 includes the collection coupling portion 62 that can be coupled to the liquid discharge portion 71 of the liquid container 18, and a collection container portion 61 capable of collecting liquid. The collection container portion 61 is capable of collecting liquid collected from the liquid container 18 through the coupling between the liquid discharge portion 71 and the collection coupling portion 62. The collection container 60 also includes an atmospheric connection portion 64 that connects the inside of the collection container portion 61 to the atmosphere.

As illustrated in FIG. 11, in an upper portion of a side surface of the collection container 60, the same number of collection coupling portions 62 as the number of liquid containers 18 in one liquid ejecting apparatus 11 are provided at intervals in the width direction X. These intervals correspond to the width dimensions of the plurality of liquid containers 18. Hence, a plurality of liquid containers 18 can be coupled to the collection container 60 simultaneously. The atmospheric connection portion 64 protrude upward from an upper surface of the collection container portion 61. The atmospheric connection portion 64 is connected to a collection compartment 61A. Note that if there is one collection compartment 61A in the collection container 60, the number of atmospheric connection portions 64 may be one or more.

Among a plurality of liquid containers 18, at least one liquid container 18 separated from the one end portion of the supply passage 24 is coupled to the collection container 60 illustrated in FIG. 10. As illustrated in FIG. 11, the liquid discharge portion 71 of the liquid container 18 and the collection coupling portion 62 of the collection container 60 are coupled to each other. The liquid in the liquid container 18 is moved by its hydraulic head pressure, and is thereby collected in the collection container 60. Thus, the liquid in the liquid container 18 can be collected in the collection container 60 by hydraulic head pressure.

### Collection of Liquid in Liquid Container 18

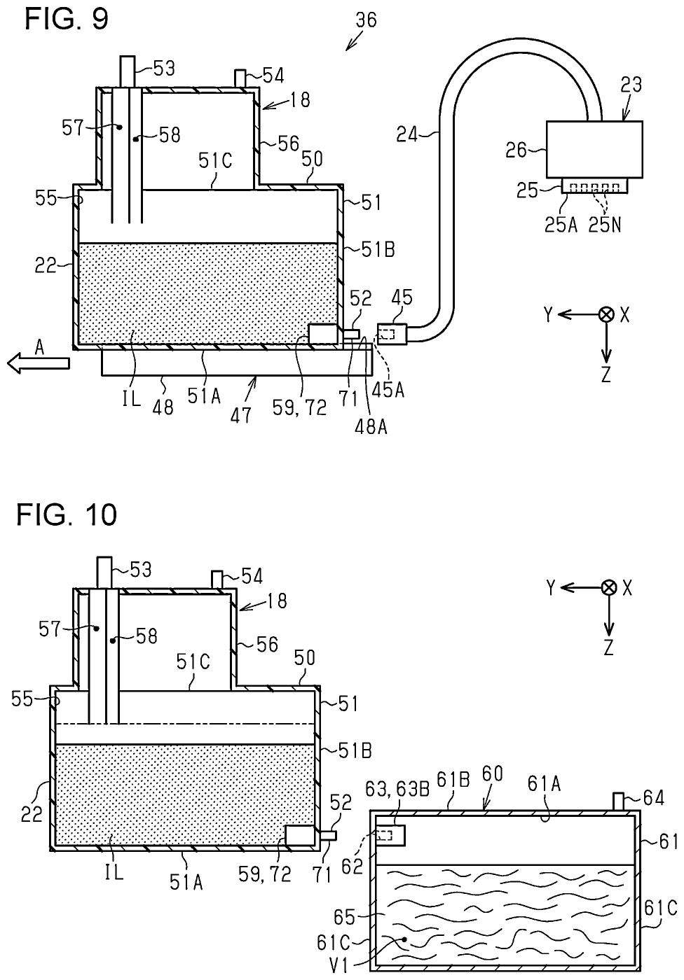

Next, a configuration and processing for collecting liquid in the liquid container 18 will be described with reference to FIGS. 9 to 12.

In a first example, the liquid container 18 can be pulled out of the casing 20 of the liquid ejecting apparatus 11 along the coupling direction of the liquid supply portion 52 and the supply passage 24. As described earlier, the door body 19B (see FIG. 1) forming the front surface portion of the storage portion 19 is attachable and detachable, and is removed by sliding the door body 19B in the upper direction −Z or the width direction X. Thereafter, as illustrated in FIG. 9, the liquid container 18 is moved in a first direction indicated by a white arrow in FIG. 9 which is the coupling direction of the liquid supply portion 52 and the connection portion 45. This movement of the liquid container 18 in the first direction removes the connection portion 45 from the liquid supply portion 52. At this time, the first valve 59 is switched to the closed-valve state from the open-valve state. Therefore, as illustrated in FIG. 9, leakage of liquid from the liquid supply portion 52 is curbed even when the liquid supply portion 52 is exposed. The liquid in the removed liquid container 18 is collected in the collection container 60 illustrated in FIG. 10, for example.

### Configuration of Collection Container 60

Next, a configuration of the collection container 60 will be described with reference to FIGS. 10 to 12.

The collection container 60 illustrated in FIG. 10 is prepared by the user when disposing of the liquid ejecting apparatus 11, for example. The collection container 60 includes the collection container portion 61 that collects liquid discharged from the liquid discharge portion 71 of the liquid container 18, and the collection coupling portion 62 that can be coupled to the liquid discharge portion 71. The collection container 60 collects residual liquid in the liquid container 18 through the coupling between the liquid discharge portion 71 and the collection coupling portion 62. The collection coupling portion 62 is located in an upper surface 61B or an upper portion of a side surface 61C of the collection container portion 61. In the example illustrated in FIG. 10, the collection coupling portion 62 is located in an upper portion of the side surface 61C of the collection container portion 61. The collection container portion 61 includes the collection compartment 61A.

The collection container 60 includes a sealing member 63 that prevents leakage of liquid through the passage of the collection coupling portion 62. The sealing member 63 may be a sealing valve 63B that prevents leakage of liquid through the passage of the collection coupling portion 62. The sealing valve 63B may be an opening and closing valve for the collection coupling portion 62 to open and close the passage for collecting liquid. For example, in a non-coupled state illustrated in FIG. 10 where the collection coupling portion 62 is not coupled to the liquid discharge portion 71 on the liquid container 18 side, the sealing valve 63B is in a closed-valve state. On the other hand, in a coupled state illustrated in FIG. 12 where the collection coupling portion 62 is coupled to the liquid discharge portion 71, the sealing valve 63B is in an open-valve state. Thus, the sealing valve 63B may be automatically switched between open and closed states depending on whether or not the liquid discharge portion 71 and the collection coupling portion 62 are coupled to each other.

For example, the collection coupling portion 62 side has a valve body (not illustrated) that is displaced against the energizing force of an energizing member when the liquid discharge portion 71 is coupled to the collection coupling portion 62, and the displaced valve body separating from a valve seat (not illustrated) switches the sealing valve 63B to the open-valve state from the closed-valve state. Moreover, when the liquid discharge portion 71 is removed from the collection coupling portion 62, the valve body on the collection coupling portion 62 side is restored to the original position by the energizing force of the energizing member and abuts on the valve seat, whereby the sealing valve 63B is switched to the closed-valve state from the open-valve state.

As illustrated in FIG. 10, the collection container 60 also includes the atmospheric connection portion 64. The atmospheric connection portion 64 connects the collection compartment 61A to the outside. The atmospheric connection portion 64 connects the collection compartment 61A to the outside via an atmospheric connection path including pores formed of meandering paths.

As illustrated in FIG. 12, when the liquid discharge portion 71 of the liquid container 18 and the collection coupling portion 62 of the collection container 60 are coupled to each other, the liquid in the liquid container 18 is moved to the collection container 60 by hydraulic head pressure. That is, when the liquid discharge portion 71 of the liquid container 18 and the collection coupling portion 62 of the collection container 60 are coupled to each other, an inner bottom surface of the liquid compartment 55 in the liquid container 18 is set to be higher than the highest liquid level when the maximum amount of liquid is collected in the collection compartment 61A of the collection container 60. Here, the maximum amount of liquid is the sum of the maximum amounts of liquid storable in the plurality of liquid containers 18.

In addition, when the liquid discharge portion 71 and the collection coupling portion 62 are coupled to each other, an amount of air corresponding to the volume of the liquid that flowed into the collection container 60 from the liquid container 18 is discharged from the atmospheric connection portion 64, so that the liquid continuously flows into the collection container 60 from the liquid container 18. The capacity of the collection container 60 is larger than the entire storable capacity of the liquid container 18. Hence, the liquid does not spill on the collection container 60 side.

In addition, as illustrated in FIGS. 10 and 12, the collection container 60 may have, in the collection container portion 61, a liquid holding member 65 capable of holding liquid. The liquid holding member 65 is enclosed inside the liquid collection container 60. The liquid holding member 65 is a liquid absorbing member capable of holding liquid by absorbing the liquid. The liquid holding member 65 may be, for example, a non-woven fabric or a porous material such as a sponge or a foam-like member. The liquid holding member 65 is accommodated in the collection compartment 61A in a volume capable of holding an amount of liquid corresponding to the maximum capacity of liquid stored in the liquid container 18. The collection container 60 is configured such that the liquid stored therein does not spill even if the collection container 60 is tilted because the liquid is held by the liquid holding member 65. Note that in the present embodiment, the liquid ejecting system may be formed of the collection container 60 and the liquid ejecting apparatus 11.

As illustrated in FIG. 11, there are the same number of collection coupling portions 62 as the liquid containers 18 or less. Additionally, as illustrated in FIGS. 10 and 11, the inside of the liquid collection container 60 is formed as one space as a whole. In the example illustrated in FIG. 11, a plurality of collection coupling portions 62 are provided in the collection container 60. There are the same number of collection coupling portions 62 as the liquid containers 18 assembled to the liquid ejecting apparatus 11, for example. As illustrated in FIGS. 10 and 11, the liquid storable capacity of the collection container 60 is V1. In the example of this collection container 60, although the liquid holding member 65 is enclosed, a liquid of a capacity V1 can be stored.

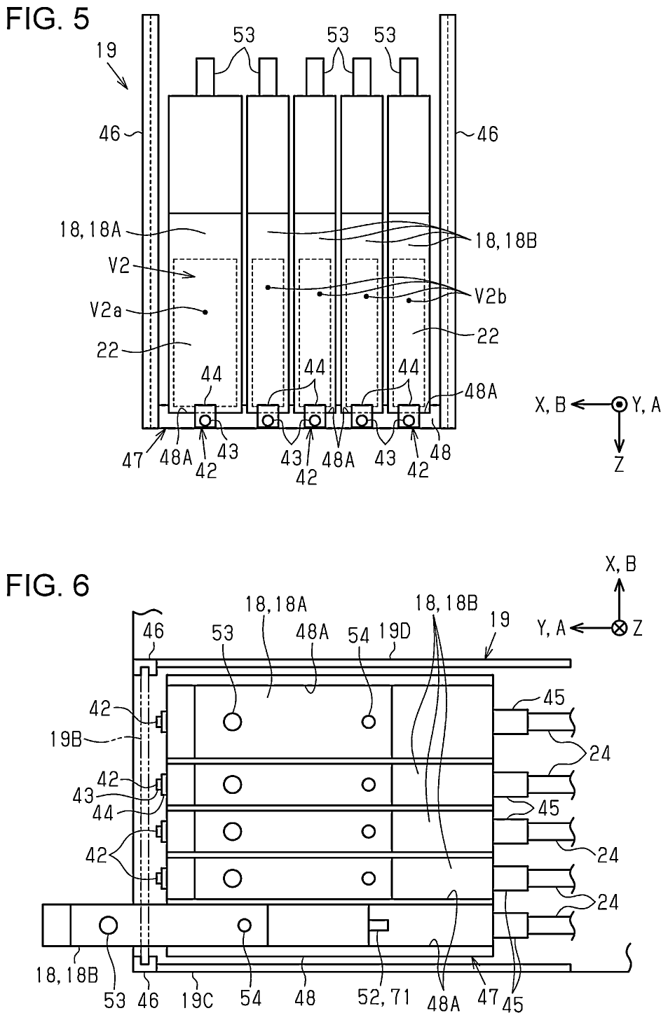

On the other hand, the total liquid capacity storable in a plurality of liquid containers 18 included in one liquid ejecting apparatus 11 is V2. The capacity V1 of the collection container 60 is set to a larger value than the total liquid capacity V2. As illustrated in FIG. 10, the capacity V1 of liquid collectable by the liquid collection container 60 is larger than the total liquid capacity V2 which is the entire capacity of liquid storable in the liquid container 18 illustrated in FIG. 5. The capacity V1 of liquid collectable by the collection container 60 is set larger than the total liquid capacity V2 which is the sum of the amounts of liquid storable in the plurality of liquid containers 18. A capacity V2a of liquid storable in the first liquid container 18A and a capacity V2b of liquid storable in the second liquid container 18B are defined. The total liquid capacity V2 which is the sum of capacities of liquid storable in the plurality of liquid containers 18 is V2=V2a+4*V2b. The capacity V1 of the collection container 60 is set to a larger value than the total liquid capacity V2. Hence, even if all of the plurality of liquid containers 18 store the full amount of liquid, all of the liquid can be collected in the collection container 60.

### Effect of First Embodiment

Next, effects of the liquid ejecting apparatus 11 including the liquid container 18 of the first embodiment will be described. Effects of a liquid ejecting system including the liquid ejecting apparatus 11 and the collection container 60 will also be described.

When disposing of the liquid ejecting apparatus 11, the user obtains the collection container 60. The collection container 60 may be packaged together with the liquid ejecting apparatus 11 at the time of purchase of the liquid ejecting apparatus 11, or the user may order the collection container 60 from a manufacturer, distributor, or the like at the time of disposal of the liquid ejecting apparatus 11. Note that the collection container 60 may be paid for or free of charge. Alternatively, the collection container 60 inserted and attached to a recessed portion of the casing 20 of the liquid ejecting apparatus 11 may be taken out of the recessed portion after removing a cover.

In the liquid ejecting apparatus 11 illustrated in FIG. 1, the user opens the image reading apparatus 13 and the cover 32 as illustrated in FIG. 2. Furthermore, the user slides the door body 19B forming the front surface portion of the storage portion 19 upward, for example, to remove it from the casing 20. When the door body 19B is removed, the front (+Y direction side) of the liquid container 18 in the storage portion 19 is opened.

Next, the fixing by the fixing portions 42 is released. To be specific, the restriction members 44 are removed by loosening the screws 43. As a result, the liquid container 18 can be moved in the first direction (+Y direction).

Next, at least one of the plurality of liquid containers 18 is moved in the first direction A individually with respect to the mounting portion 48 to separate the liquid container 18 individually from one end of the supply passage 24.

As illustrated in FIGS. 4 to 6 and 9, the user slides the liquid container 18 along the guide portion 48A on the mounting portion 48 to move the liquid container 18 in the first direction A. The user moves the liquid container 18 individually one at a time in the first direction A.

The first direction A is the coupling direction of the liquid supply portion 52 and the supply passage 24. In particular, in the present example, the first direction A is the coupling direction of the liquid supply portion 52 and the connection portion 45. The first direction A may be a direction intersecting the coupling direction of the liquid supply portion 52 and the supply passage 24 or the connection portion 45 in the range of 0<θ≤20°, for example. Thus, when the user moves the liquid container 18 in the first direction A, the coupling between the liquid supply portion 52 and the supply passage 24 or the connection portion 45 can be released without applying excessive load on any of the portions.

Moreover, since the liquid container 18 is removed one by one from the casing 20, only a small force is required to move and remove the liquid container 18 in the first direction A. That is, the force required to remove the liquid container 18 is only a force corresponding to the force required to separate one coupling between the liquid supply portion 52 and the connection portion 45. Note that two or more liquid containers 18 may be moved in the first direction A simultaneously to separate the two or more liquid containers 18 from the supply passage 24 simultaneously. Alternatively, all of a plurality of liquid containers 18 may be moved in the first direction A simultaneously to separate them from the supply passage 24.

When the connection portion 45 is removed from the liquid supply portion 52, the first valve 59 is switched to the closed-valve state from the open-valve state, whereby leakage of liquid such as ink from the liquid supply portion 52 is curbed. Therefore, staining of the inside of the casing 20 with liquid such as ink is curbed as much as possible. Moreover, when the connection portion 45 is removed from the liquid supply portion 52, a valve (not illustrated) provided on the connection portion 45 side is switched to the closed-valve state from the open-valve state, whereby leakage of liquid such as ink from the connection portion 45 is also curbed.

The user may separate all of a plurality of liquid containers 18 from one end of the supply passage 24, or may selectively remove one or more liquid containers 18 after checking the remaining amount through the viewing surface 22 and determining that the liquid needs to be discharged (collected). Note that the step of removing the liquid container 18 up to this point corresponds to a step of removing the liquid container 18 from the liquid ejecting apparatus 11 before coupling the liquid discharge portion 71 and the collection coupling portion 62 to each other in a liquid collection method in a liquid ejecting system.

Next, the liquid discharge portion 71 of the liquid container 18 removed from the casing 20 and the collection coupling portion 62 of the collection container 60 are coupled to each other. This coupling switches both the second valve 72 (the same valve as the first valve 59 in the present embodiment) and the sealing valve 63B to the open-valve state from the closed-valve state. In this coupled state, the liquid level in the liquid container 18 is higher than the liquid level at the full amount in the collection container 60. Note that the coupling step here corresponds to a step of coupling the liquid discharge portion 71 of the liquid container 18 and the collection coupling portion 62 of the liquid collection container 60 to each other in the liquid collection method in the liquid ejecting system.

As a result of the coupling, the liquid in the liquid container 18 is moved to the collection container 60 by hydraulic head pressure. An amount of air corresponding to the volume of the liquid that flowed into the collection container 60 from the liquid container 18 is discharged from the atmospheric connection portion 64. As a result, the liquid continuously flows into the collection container 60 from the liquid container 18. The capacity V1 of the collection container 60 illustrated in FIG. 10 is larger than the total liquid capacity V2 which is the sum of the amounts of liquid storable in a plurality of (e.g., five) liquid containers 18 illustrated in FIG. 5. Hence, the entire liquid in the plurality of liquid containers 18 can be collected in the collection container 60. Note that the collection step here corresponds to a step of collecting the liquid in the liquid container 18 into the collection container 60 by moving the liquid by hydraulic head pressure in the liquid collection method in the liquid ejecting system.

The liquid collected in the collection container 60 is absorbed by the liquid holding member 65. Hence, even if the collection container 60 is tilted after collecting the liquid, the liquid does not leak. The user assembles the empty liquid container 18 from which residual liquid is discharged to the casing 20, and then disposes of the liquid ejecting apparatus 11.

Therefore, according to the first embodiment, the following effects can be obtained.

(1-1) A liquid ejecting system includes the liquid ejecting apparatus 11 provided with the ejection head 25 that ejects liquid and the liquid container 18 capable of storing liquid supplied to the ejection head 25, and the liquid collection container 60. The liquid container 18 includes the liquid storage portion 51 capable of storing liquid, the liquid pouring portion 53 that pours liquid into the liquid storage portion 51, the liquid supply portion 52 that supplies liquid to the ejection head 25, and the liquid discharge portion 71 that discharges the liquid stored in the liquid storage portion 51 to the outside. The liquid collection container 60 includes the collection coupling portion 62 capable of coupling with the liquid discharge portion 71, and the collection container portion 61 that stores liquid collected from the liquid container 18 through the coupling between the liquid discharge portion 71 and the collection coupling portion 62. According to this configuration, it is possible to collect residual liquid such as ink in the liquid container 18 into the liquid collection container 60 from the liquid container 18. Therefore, it is possible to reduce the load on the environment caused by liquid contamination due to residual liquid leaking from the liquid container 18 when disposing of the liquid ejecting apparatus 11.

(1-2) In the liquid ejecting system, the liquid in the liquid container 18 is moved by hydraulic head pressure of the liquid to collect the liquid in the liquid collection container 60. According to this configuration, it is possible to more smoothly collect the residual liquid in the liquid container 18 into the liquid collection container 60 by hydraulic head pressure without employing a complex configuration.

(1-3) The capacity of liquid collectable by the liquid collection container 60 is larger than the entire capacity of liquid storable in the liquid container 18. According to this configuration, it is possible to collect the entire liquid in the liquid container 18 with one liquid collection container 60.

(1-4) The collection coupling portion 62 is provided with the sealing member 63 that prevents leakage of liquid through a passage of the collection coupling portion 62. According to this configuration, it is possible to curb leakage of the collected liquid to the outside of the liquid collection container 60.

(1-5) The liquid holding member 65 is enclosed inside the liquid collection container 60. According to this configuration, it is possible to reduce the risk of the liquid collected in the liquid collection container 60 being dispersed outside.

(1-6) The same number of collection coupling portions 62 as the liquid containers 18 or less are provided, and the inside of the liquid collection container 60 is formed as one space as a whole. According to this configuration, since the liquid in the liquid containers 18 can be collected in the liquid collection container 60 altogether, it is possible to dispose of the collected liquid altogether.

(1-7) The liquid collection container 60 includes the collection coupling portion 62 capable of coupling with the liquid discharge portion 71 of the liquid container 18, the collection container portion 61 that stores liquid collected from the liquid container 18 through the collection coupling portion 62 coupled to the liquid discharge portion 71, and the atmospheric connection portion 64 that connects the inside of the collection container portion 61 to the atmosphere. According to this configuration, it is possible to collect residual liquid such as ink in the liquid container 18 into the liquid collection container 60 smoothly from the liquid container 18. Therefore, it is possible to reduce the load on the environment caused by liquid contamination due to residual liquid leaking from the liquid container 18 when disposing of the liquid ejecting apparatus 11.

(1-8) The liquid collection container 60 includes the sealing member 63 that prevents leakage of liquid through a passage of the collection coupling portion 62. According to this configuration, since the sealing member 63 that prevents leakage of liquid through the passage of the collection coupling portion 62 is provided, it is possible to curb leakage of liquid in the liquid collection container 60 from a discharge coupling portion after collection of the liquid.

(1-9) A liquid collection method of collecting liquid in the liquid container 18 provided in the liquid ejecting apparatus 11 in the liquid ejecting system may include the following two steps. (a) Coupling the liquid discharge portion 71 of the liquid container 18 and the collection coupling portion 62 of the liquid collection container 60 to each other. (b) Moving and collecting the liquid in the liquid container 18 into the liquid collection container 60 by hydraulic head pressure.

According to this method, it is possible to collect residual liquid such as ink in the liquid container 18 from the liquid container 18 to the liquid collection container 60. Therefore, it is possible to reduce the load on the environment caused by liquid contamination due to leakage of residual liquid such as residual ink in the liquid container 18 when disposing of the liquid ejecting apparatus 11.

(1-10) The liquid collection method may further include the following (c). (c) Removing the liquid container 18 from the liquid ejecting apparatus 11 before coupling the liquid discharge portion 71 and the collection coupling portion 62 to each other. According to this method, the liquid container 18 is removed from the liquid ejecting apparatus 11 before coupling the liquid discharge portion 71 and the collection coupling portion 62 to each other. Therefore, it is possible to couple the liquid discharge portion 71 and the collection coupling portion 62 to each other more easily as compared to a method of coupling the liquid discharge portion 71 and the collection coupling portion 62 to each other without removing the liquid container 18 from the liquid ejecting apparatus 11.

### Second Embodiment

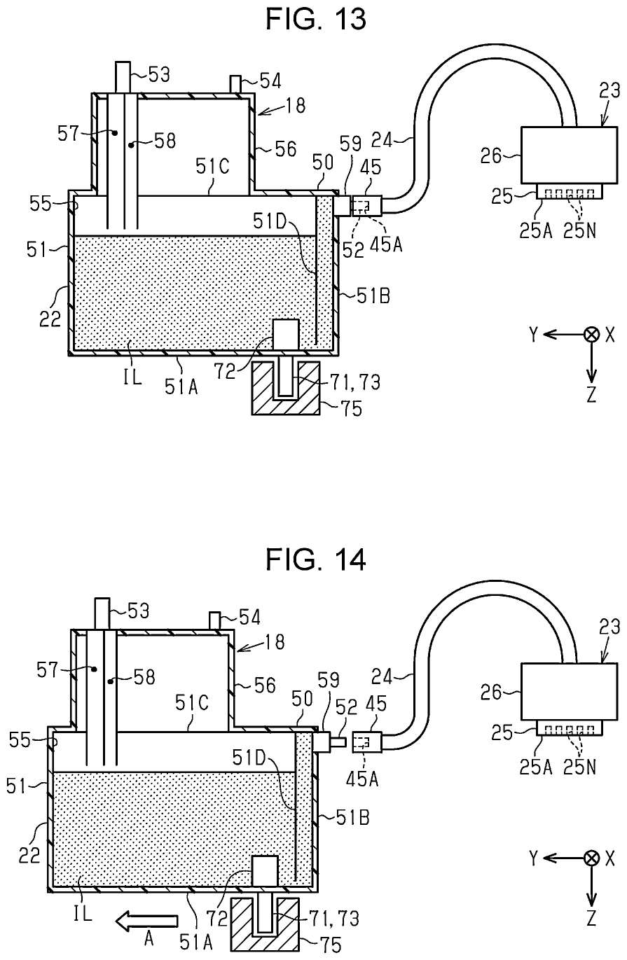

Next, a configuration of a liquid container 18 and a collection container 60 which are a part of a liquid ejecting system of a second embodiment with reference to FIGS. 13 to 18. The basic configuration of a liquid ejecting apparatus 11 is the same as the first embodiment. Hence, in the following, the configuration of the liquid ejecting apparatus 11 will be described by assigning the same reference numerals as the first embodiment and omitting detailed descriptions, focusing mainly on the configuration and the like of the liquid container 18 and the collection container 60. Note that the configuration of the liquid container 18 and the collection container 60, too, will be described by assigning the same reference numerals to configurations common to the first embodiment and omitting detailed descriptions.

As illustrated in FIGS. 13 and 14, the liquid container 18 of the second embodiment includes a liquid supply portion 52 and a liquid discharge portion 71 separate from each other. That is, in this example, the liquid discharge portion 71 for discharging liquid in the liquid container 18 to the outside is provided separately from the liquid supply portion 52.

As illustrated in FIGS. 13 and 14, the basic configuration of the liquid container 18 is the same as the first embodiment. That is, as illustrated in FIGS. 13 and 14, the liquid container 18 includes a liquid storage portion 51 capable of storing liquid and a liquid pouring portion 53 that pours liquid into the liquid storage portion 51. Furthermore, the liquid container 18 includes the liquid supply portion 52 that is a part to which one end portion of a supply passage 24 supplying liquid to an ejection head 25 is coupled and that supplies liquid in the liquid storage portion 51, and the liquid discharge portion 71 that discharges the liquid stored in the liquid storage portion 51. The liquid supply portion 52 is located in an upper portion of a side surface 51B of the liquid container 18. The inside of a liquid compartment 55 of the liquid storage portion 51 is partitioned into a region storing liquid and a supply passage guiding liquid to the liquid supply portion 52 by a passage forming wall 51D extending downward from a partition wall portion 51C.

The liquid supply portion 52 is capable of connecting to a connection portion 45 provided in an upstream end portion of the supply passage 24. When the liquid supply portion 52 is connected (coupled) to the connection portion 45, the liquid supply portion 52 is coupled to a coupling port 46 of the connection portion 45. The liquid discharge portion 71 is arranged in a bottom surface 51A or a lower portion of the side surface 51B of the liquid storage portion 51. Note that in the example illustrated in FIGS. 13 and 14, the liquid discharge portion 71 is arranged in the bottom surface 51A of the liquid storage portion 51. The liquid discharge portion 71 protrudes downward from the bottom surface 51A of the liquid storage portion 51.

The liquid container 18 also includes a first valve 59 capable of opening and closing a passage of the liquid supply portion 52. The liquid container 18 has a second valve 72 capable of opening and closing a passage of the liquid discharge portion 71. In the second embodiment, the liquid supply portion 52 and the liquid discharge portion 71 are provided separately, and therefore the first valve 59 and the second valve 72 are also provided separately. The valve structure and function of the first valve 59 and the valve structure and function of the second valve 72 are the same as the first embodiment.

That is, the first valve 59 has a valve body, a valve seat, and an energizing member (e.g., spring) that energizes the valve body in a direction of abutting on the valve seat. For example, when the connection portion 45 is coupled to the liquid supply portion 52, the valve body at the back of the liquid supply portion 52 is separated from the valve seat by a force received from the connection portion 45, whereby the first valve 59 is switched to the open-valve state from the closed-valve state. When the connection portion 45 is removed from the liquid supply portion 52, the valve body comes into contact with the valve seat by the energizing force of the energizing member, so that the first valve 59 is switched to the closed-valve state from the open-valve state.

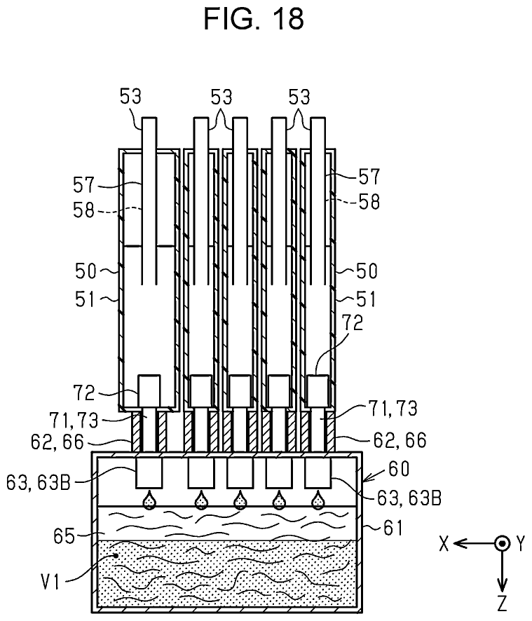

The second valve 72 has a valve body, a valve seat, and an energizing member (e.g., spring) that energizes the valve body in a direction of abutting on the valve seat. For example, when a collection coupling portion 62 of the liquid collection container 60 described later is coupled to the liquid discharge portion 71, the valve body is retracted in a direction of separating from the valve seat by a force received from the collection coupling portion 62 (see FIG. 18), whereby the second valve 72 is switched to the open-valve state from the closed-valve state. Moreover, when the collection coupling portion 62 is removed from the liquid discharge portion 71, the valve body comes into contact with the valve seat by the energizing force of the energizing member, so that the second valve 72 is switched to the closed-valve state from the open-valve state.

Next, as illustrated in FIGS. 13 and 14, there is provided a cap member 75 that is attached in a detachable manner to the liquid discharge portion 71 of the liquid container 18 and that seals the liquid discharge portion 71 when the liquid discharge portion 71 is not coupled to a coupling target.

As illustrated in FIGS. 13 and 14, by fitting the cap member 75 into the liquid discharge portion 71, the liquid discharge portion 71 is sealed. The cap member 75 is attached by being fitted or screwed into the liquid discharge portion 71, for example.

### Configuration of Liquid Ejecting System

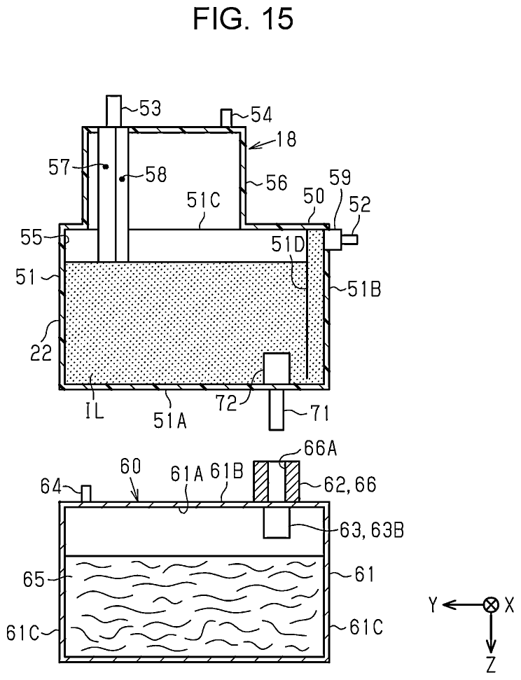

Next, the liquid container 18 and the collection container 60 will be described with reference to FIGS. 15 to 18.

In the present embodiment, a liquid ejecting system is formed of the liquid ejecting apparatus 11 and the collection container 60. The liquid ejecting apparatus 11 and the collection container 60 may be sold as a set, or the user may obtain the collection container 60 for a fee or free of charge at the stage of disposal of the liquid ejecting apparatus 11. Alternatively, a recessed portion may be provided in a casing 20 of the liquid ejecting apparatus 11, and the collection container 60 may be inserted into the recessed portion. An opening of the recessed portion may be covered with a cover. The cover may be removed to take the collection container 60 out of the recessed portion for use when disposing of the liquid ejecting apparatus 11.

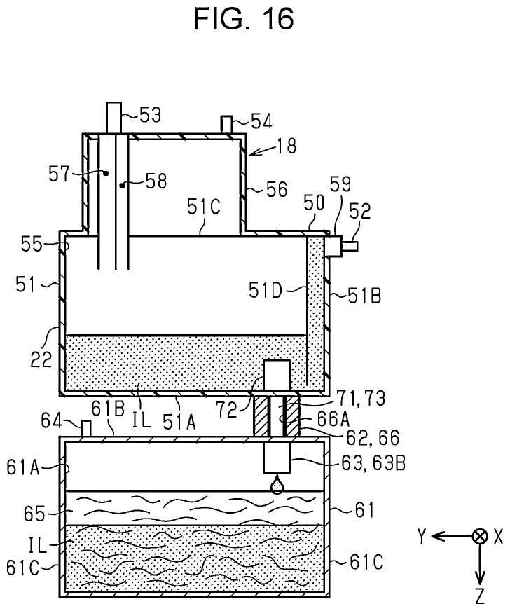

As illustrated in FIGS. 15 and 16, the collection container 60 includes a collection container portion 61 capable of storing liquid, a collection coupling portion 62 capable of coupling with the liquid discharge portion 71 of the liquid container 18, and an atmospheric connection portion 64 that connects the inside of the collection container portion 61 to the atmosphere. As illustrated in FIG. 16, the liquid collected through the coupling between the liquid discharge portion 71 and the collection coupling portion 62 from the liquid container 18 is stored in the collection container portion 61.

As in the first embodiment, the collection coupling portion 62 is provided with a sealing member 63 that prevents leakage of liquid through a passage of the collection coupling portion 62. The sealing member 63 is a sealing valve 63B that prevents leakage of liquid through the passage of the collection coupling portion 62. As in the first embodiment, a liquid holding member 65 is enclosed inside the collection container 60.

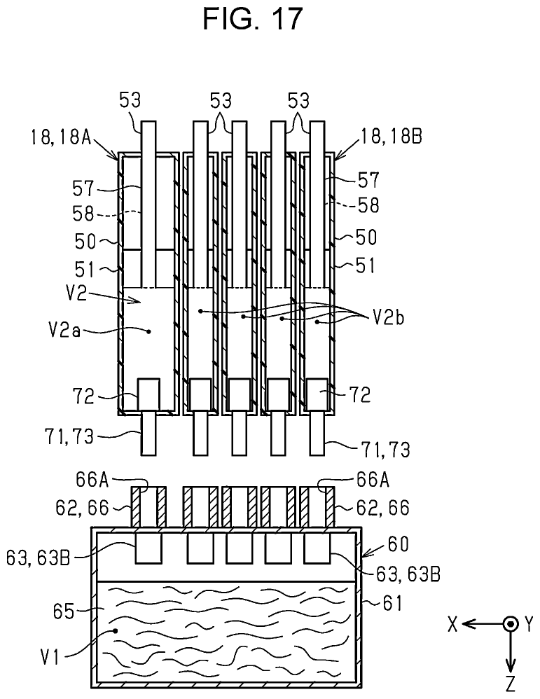

As illustrated in FIG. 17, there are the same number of collection coupling portions 62 as the liquid containers 18 or less. Additionally, as illustrated in FIGS. 15 and 17, the inside of the liquid collection container 60 is formed as one space as a whole. In the example illustrated in FIG. 17, a plurality of collection coupling portions 62 are provided in the collection container 60. There are the same number of collection coupling portions 62 as the liquid containers 18 assembled to the liquid ejecting apparatus 11, for example.

As illustrated in FIG. 17, in an upper portion of the collection container 60, the same number of collection coupling portions 62 as the number of liquid containers 18 in one liquid ejecting apparatus 11 are provided at intervals in the width direction X. These intervals correspond to the width dimensions of the plurality of liquid containers 18. Hence, a plurality of liquid containers 18 can be coupled to the collection container 60 simultaneously. The atmospheric connection portion 64 protrudes upward from an upper surface of the collection container portion 61. The atmospheric connection portion 64 is connected to a collection compartment 61A. Note that if there is one collection compartment 61A in the collection container 60, the number of atmospheric connection portions 64 may be one or more.

As illustrated in FIG. 17, a capacity V1 of liquid collectable by the liquid collection container 60 is larger than a total liquid capacity V2 which is the entire capacity of liquid storable in the liquid container 18. The capacity V1 of liquid collectable by the collection container 60 is set larger than the total liquid capacity V2 which is the sum of the amounts of liquid storable in the plurality of liquid containers 18. A capacity V2a of liquid storable in a first liquid container 18A and a capacity V2b of liquid storable in a second liquid container 18B are defined. The total liquid capacity V2 which is the sum of capacities of liquid storable in the plurality of liquid containers 18 is V2=V2a+4*V2b. The capacity V1 of the collection container 60 is set to a larger value than the total liquid capacity V2. Note that although the liquid holding member 65 is enclosed in the collection container 60 in the example illustrated in FIG. 17 and other drawings, the liquid capacity of the collection container 60 excluding the volume of the liquid holding member 65 is set to the capacity V1 larger than the total liquid capacity V2.

As illustrated in FIG. 17, the collection container 60 is placed below the liquid container 18 removed from the casing 20. The collection coupling portion 62 is formed of a cylinder portion 66 having a recessed portion 66A into which the liquid discharge portion 71 formed of a tube portion 73 can be fitted. Then, as illustrated in FIGS. 16 and 18, the liquid discharge portion 71 of the liquid container 18 and the collection coupling portion 62 of the collection container 60 are coupled to each other. Then, both the second valve 72 and the sealing valve 63B are switched to the open-valve state from the closed-valve state.

Of the plurality of liquid containers 18, the plurality of liquid containers 18 separated from one end portion of the supply passage 24 is coupled altogether to the collection container 60 illustrated in FIG. 18. As illustrated in FIG. 18, the liquid discharge portion 71 of the liquid container 18 and the collection coupling portion 62 of the collection container 60 are coupled to each other. The liquid in the liquid container 18 can be collected in the liquid collection container 60 by hydraulic head pressure.

The collection container 60 collects substantially the entire liquid in the liquid container 18 without spilling. The liquid collected in the collection container 60 is absorbed by the liquid holding member 65. Therefore, even if the collection container 60 is tilted, the liquid does not leak. Then, the user returns the empty liquid container 18 from which the residual liquid is discharged to the collection container 60 to the original storage portion 19. The user disposes of the liquid ejecting apparatus 11 with an empty liquid container 18 with no residual liquid left therein.

### Effect of Second Embodiment

Next, effects of the liquid ejecting apparatus 11 including the liquid container 18 of the second embodiment will be described. Effects of a liquid ejecting system including the liquid ejecting apparatus 11 and the collection container 60 will also be described.

When disposing of the liquid ejecting apparatus 11, the user obtains the collection container 60. As in the first embodiment, the user moves the liquid container 18 in a first direction A indicated by a white arrow in FIG. 13 by sliding, for example. The first direction A is the coupling direction of the liquid supply portion 52 and the supply passage 24. In particular, in the present example, the first direction A is the coupling direction of the liquid supply portion 52 and the connection portion 45 which is one end portion of the supply passage 24.

Even when the connection portion 45 is removed from the liquid supply portion 52, the first valve 59 is switched to the closed-valve state from the open-valve state, so that leakage of liquid such as ink from the liquid supply portion 52 is curbed. Therefore, staining of the inside of the casing 20 with liquid such as ink can be curbed as much as possible. Note that when the connection portion 45 is removed from the liquid supply portion 52, a valve (not illustrated) provided on the connection portion 45 side is switched to the closed-valve state from the open-valve state.

When the liquid container 18 is removed from the casing 20, the cap member 75 is removed from the liquid discharge portion 71 of the liquid container 18. Next, as illustrated in FIGS. 15 and 17, the collection container 60 is placed below the liquid container 18. The collection container 60 includes a collection container portion 61 having a collection compartment 61A. The collection container 60 has, in an upper surface 61B of the collection container portion 61, the collection coupling portion 62 that is a part coupled to the liquid discharge portion 71. The collection coupling portion 62 has a tube shape, and has, in the tube, the recessed portion 66A into which the pipe-shaped liquid discharge portion 71 can be fitted. Then, as illustrated in FIGS. 16 and 18, the liquid discharge portion 71 of the liquid container 18 and the collection coupling portion 62 of the collection container 60 are coupled to each other. Then, both the second valve 72 and the sealing valve 63B are switched to the open-valve state from the closed-valve state. The liquid inside the liquid container 18 is moved to the collection container 60 by hydraulic head pressure. In this liquid collection process, an amount of air corresponding to the volume of the liquid that flowed into the collection container 60 from the liquid container 18 is discharged from the atmospheric connection portion 64. As a result, the liquid continuously flows into the collection container 60 from the liquid container 18. Substantially the entire liquid in the liquid container 18 is collected in the collection container 60 without spilling. The liquid collected in the collection container 60 is absorbed by the liquid holding member 65. Therefore, even if the collection container 60 is tilted, the liquid does not leak. Then, after removing the residual liquid in the liquid container 18, the user disposes of the liquid ejecting apparatus 11.

As has been described, in the second embodiment, too, liquid in the liquid container 18 is collected by the same liquid collection method in the liquid ejecting system as in the first embodiment. That is, the liquid collection method includes three steps. The first is a step of removing the liquid container 18 from the liquid ejecting apparatus 11 before coupling the liquid discharge portion 71 and the collection coupling portion 62 to each other. The second is a step of coupling the liquid discharge portion 71 of the liquid container 18 and the collection coupling portion 62 of the collection container 60 to each other. The third is collecting the liquid in the liquid container 18 into the collection container 60 by moving the liquid by hydraulic head pressure.

Therefore, according to the second embodiment, the effects (1-1) to (1-10) of the first embodiment can be obtained in the same manner.

### Third Embodiment

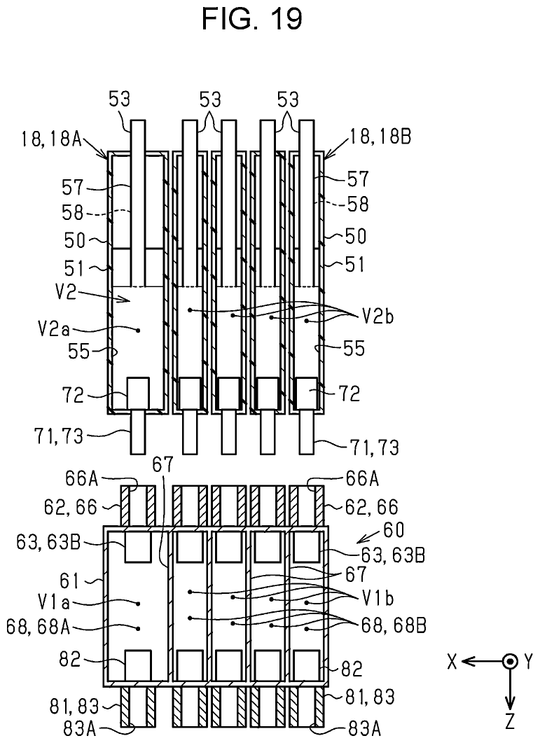

Next, a configuration of t liquid container 18 and a collection container 60 of a third embodiment will be described with reference to FIGS. 19 to 23. The basic configuration of a liquid ejecting apparatus 11 is the same as the first embodiment. Note that configurations of the liquid container 18 and the collection container 60 common to the second embodiment are assigned the same reference numerals and detailed descriptions will be omitted.

As illustrated in FIGS. 19 to 23, the liquid container 18 has the same configuration as the second embodiment. The collection container 60 of the present embodiment has a function of returning liquid collected from the liquid container 18 to the liquid container 18. In addition to the use of collecting residual liquid in the liquid container 18 at the time of disposal of the liquid ejecting apparatus 11, this function can be used when the liquid in the liquid container 18 needs to be discharged temporarily due to circumstances such as transport or maintenance of the liquid ejecting apparatus 11.

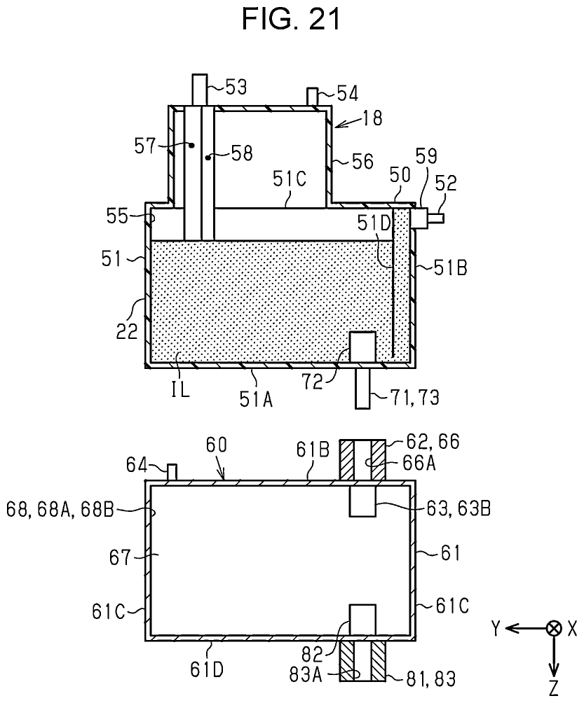

The liquid collection container 60 of the present embodiment includes a collection container portion 61, a collection coupling portion 62, and an atmospheric connection portion 64 (see FIG. 21). The collection coupling portion 62 is capable of coupling with a liquid discharge portion 71 of the liquid container 18. The collection container portion 61 stores liquid collected from the liquid container 18 through the collection coupling portion coupled with the liquid discharge portion. The atmospheric connection portion 64 connects the inside of the collection container portion 61 with the atmosphere.

A plurality of collection coupling portions 62 is formed according to the number of the liquid containers 18. The inside of the collection container 60 is partitioned into the same number of spaces as the number of liquid containers 18. To be specific, the collection container 60 is partitioned into a plurality of collection compartments 68 by a partition wall portion 67. In an upper surface 61B of the collection container 60, a plurality of collection coupling portions 62 respectively corresponding to the plurality of collection compartments 68 are provided in a protruding manner. The collection coupling portion 62 is formed of a cylinder portion 66 having a recessed shape having a recessed portion 66A that can be fitted into a pipe-shaped liquid discharge portion 71 having a protruding shape.

The collection coupling portion 62 is provided with a sealing member 63 that prevents leakage of liquid through a passage of the collection coupling portion 62. The sealing member 63 is a sealing valve 63B capable of opening and closing the passage of the collection coupling portion 62, for example.

The sealing valve 63B has a valve body energized in a direction of advancing outward by an energizing member (not illustrated) while being advanceable and retractable in its axial direction, and a valve seat on which the energized valve body abuts. When the collection coupling portion 62 is coupled to the liquid discharge portion 71 of the liquid container 18, the valve body is separated from the valve seat by a force received from the liquid discharge portion 71, whereby the sealing valve 63B is switched to the open-valve state from the closed-valve state. Moreover, when the liquid discharge portion 71 is removed from the collection coupling portion 62, the valve body comes into contact with the valve seat by the energizing force of the energizing member, so that the sealing valve 63B is switched to the closed-valve state from the open-valve state. Hence, leakage of the liquid from the collection coupling portion 62 in the collection container 60 can be curbed after collection of the liquid ends.

As illustrated in FIG. 19, in an upper surface portion of the collection container 60, the same number of collection coupling portions 62 as the number of liquid containers 18 in one liquid ejecting apparatus 11 are provided at intervals in a width direction X. These intervals correspond to the width dimensions of the plurality of liquid containers 18. Hence, a plurality of liquid containers 18 can be coupled to the collection container 60 simultaneously.

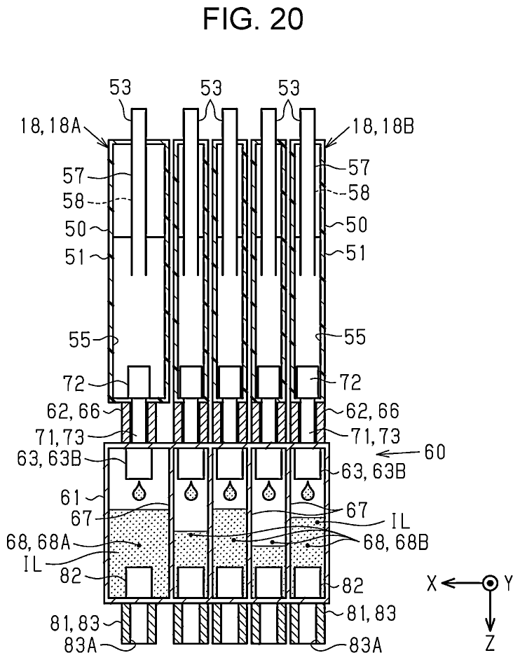

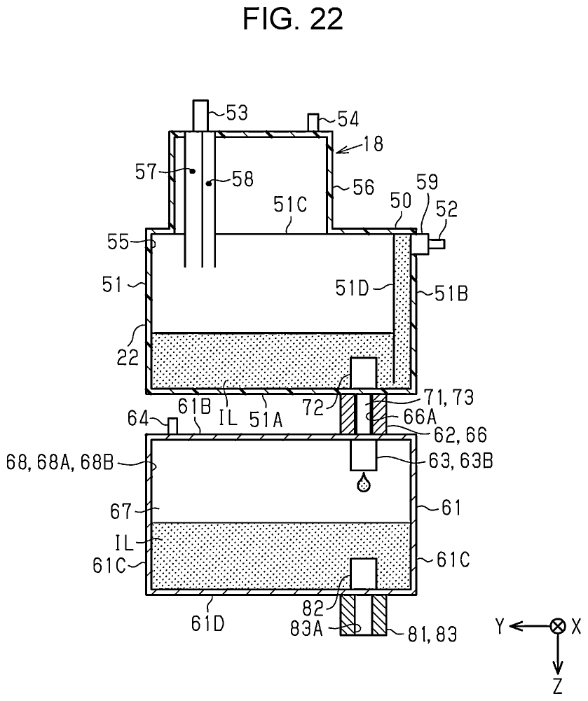

Additionally, as illustrated in FIGS. 20 and 22, the liquid discharge portion 71 of the liquid container 18 and the collection coupling portion 62 of the collection container 60 are coupled to each other. Then, both a second valve 72 and the sealing valve 63B are switched to the open-valve state from the closed-valve state. The liquid in the liquid container 18 is collected in the collection container 60 by being moved to the collection container 60 by hydraulic head pressure.

As illustrated in FIGS. 19 and 21, the collection container 60 of the present embodiment has a liquid re-supply portion 81 as a liquid supply port for returning the liquid collected in the collection container portion 61 to the liquid container 18. That is, the collection container 60 has the liquid re-supply portion 81 that can be coupled to a liquid pouring portion 53. The liquid re-supply portion 81 is provided in a lower portion of the collection container portion 61. The liquid re-supply portion 81 is formed separately from the collection coupling portion 62. That is, as illustrated in FIGS. 19 and 21, while the collection coupling portion 62 is provided in an upper portion of the collection container portion 61, the liquid re-supply portion 81 is provided in a lower portion of the collection container portion 61. Note that the liquid re-supply portion 81 is not limited to being provided on a bottom surface of the collection container portion 61 as illustrated in FIGS. 19 and 21, and may be provided in a lower portion of a side surface of the collection container portion 61.

As illustrated in FIGS. 19 and 21, the liquid re-supply portion 81 is formed of a tube portion 83. The tube portion 83 has an inner diameter dimension that can be fitted into the liquid pouring portion 53 on the liquid container 18 side. To be specific, the liquid re-supply portion 81 is formed of the tube portion 83 having a recessed shape that can be fitted into the liquid pouring portion 53 having a protruding shape. The tube portion 83 has a recessed portion 83A having an inner diameter dimension that can be externally fitted into a tube portion of the liquid pouring portion 53. Note that the protrusion-recess relationship between the liquid re-supply portion 81 and the liquid pouring portion 53 may be opposite, for example, and the liquid re-supply portion 81 may have a protruding shape and the liquid pouring portion 53 may have a recessed shape.

The liquid re-supply portion 81 has a valve 82 capable of opening and closing a passage of the liquid re-supply portion 81. The valve 82 has, for example, a valve body energized by an energizing member (not illustrated) in a direction of advancing outward while being advanceable and retractable in its axial direction, and a valve seat on which the energized valve body abuts. When the liquid re-supply portion 81 is coupled to the liquid pouring portion 53 of the liquid container 18, the valve body is separated from the valve seat by a force received from the liquid pouring portion 53, whereby the valve 82 is switched to the open-valve state from the closed-valve state. Moreover, when the liquid re-supply portion 81 is removed from the liquid pouring portion 53, the valve body comes into contact with the valve seat by the energizing force of the energizing member, so that the valve 82 is switched to the closed-valve state from the open-valve state. Hence, leakage of liquid from the liquid re-supply portion 81 is curbed during collection and after collection of liquid in the collection container 60, and also in the process of returning the liquid to the liquid container 18.

Here, as illustrated in FIG. 19, capacities V1a and V1b of liquid collectable by a plurality of collection compartments 61A partitioned inside the collection container 60 are set larger than capacities V2a and V2b storable in the plurality of liquid containers 18. A capacity V2a storable in a first liquid container 18A and a capacity V2b storable in a second liquid container 18B are defined. The capacity V1a of a first collection compartment 68A in the collection container 60 is set to a larger value than the capacity V2a of the first liquid container 18A. In addition, the capacity V1b of a second collection compartment 68B in the collection container 60 is set to a larger value than the capacity V2b of the second liquid container 18B. Note that the capacity of the liquid container 18 is the amount of liquid when the liquid level reaches the lower end of an air passage 58. The capacity of the collection container 60 is, for example, the amount of liquid when the liquid level is below the connecting position of the atmospheric connection portion 64 and slightly below the opening and closing position of the sealing valve 63B. Note that the capacity V1 of the collection container 60 may be set to an appropriate value considering prevention of leakage of collected liquid. Note that as illustrated in FIGS. 19 to 22, in the present embodiment, the collection container 60 does not accommodate the liquid holding member 65.

As illustrated in FIG. 21, an atmospheric connection portion 64 protrudes upward from an upper surface 61B of the collection container portion 61. The atmospheric connection portion 64 is connected to the collection compartment 68 at a position above the liquid level at the maximum liquid level in the collection compartment 68.

As illustrated in FIGS. 20 and 22, the liquid discharge portion 71 of the liquid container 18 and the collection coupling portion 62 of the collection container 60 are coupled to each other. The liquid in the liquid container 18 is moved by hydraulic head pressure and is collected in the collection container 60. In the present embodiment, as illustrated in FIG. 20, the liquid in the plurality of liquid containers 18 are collected separately in a plurality of collection compartments 68 for each color. Note that while FIG. 20 illustrates an example in which all of a plurality of liquid containers 18 are coupled to the collection container 60 simultaneously, liquid of one by one or less than the whole number of liquid containers 18 may be collected in the collection container 60.

Thus, maintenance, transport, or the like of the liquid ejecting apparatus 11 is performed after liquid collection ends. After the maintenance, transport, or the like ends, the user returns the liquid in the collection container 60 to the liquid container 18.

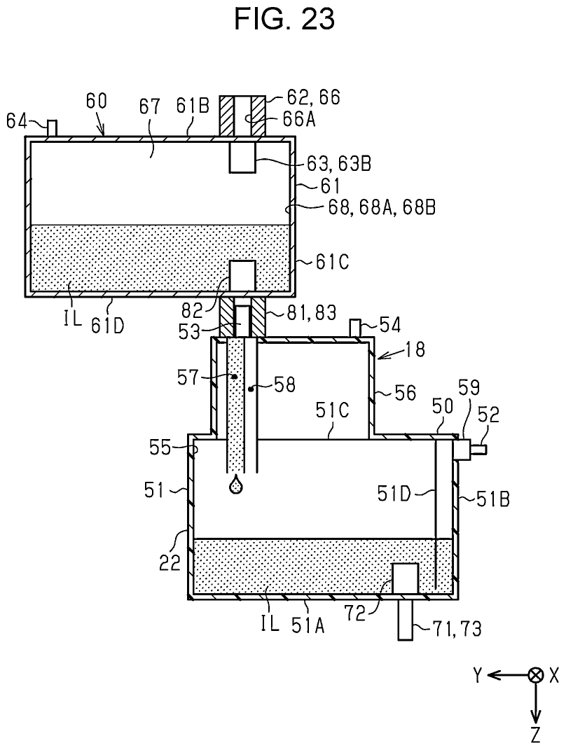

As illustrated in FIG. 23, the liquid re-supply portion 81 of the collection container 60 is coupled to the liquid pouring portion 53 of the liquid container 18. At the time of this coupling, when the liquid pouring portion 53 pushes the valve body of the sealing valve 63B, the sealing valve 63B is switched to the open-valve state from the closed-valve state. As a result, the liquid in the collection container 60 moves to the liquid container 18 through a liquid passage 57 by hydraulic head pressure.

At this time, air in the liquid compartment 55 is discharged from the atmospheric connection portion 54 to the outside as the liquid flows into the liquid container 18. As a result, the liquid in the collection container 60 continuously moves into the liquid container 18. Thus, the liquid in the collection container 60 is returned to the liquid container 18. Note that with the coupling illustrated in FIG. 23, when returning the liquid in the collection container 60 to the liquid container 18, all of the plurality of liquid containers 18 may be coupled to the collection container 60 simultaneously, or one by one or less than the whole number of liquid containers 18 may be coupled to the collection container 60.

Therefore, according to the third embodiment, the effects of (1-1) to (1-4) and (1-7) to (1-10) of the first embodiment can be obtained in the same manner, and the following effects can also be obtained.

(3-1) A plurality of collection coupling portions 62 is formed according to the number of the liquid containers 18, and the inside of the liquid collection container 60 is partitioned into the same number of spaces as the number of liquid containers 18. According to this configuration, it is possible to collect liquid in the liquid containers 18 separately in spaces partitioned inside the liquid collection container 60. It is possible to prevent mixing of different liquids considering refilling of the liquids after collection.

(3-2) The liquid collection container 60 has the liquid re-supply portion 81 that can be coupled to the liquid pouring portion 53. According to this configuration, it is possible to reuse liquid collected in the liquid collection container 60.

(3-3) The liquid re-supply portion 81 is formed separately from the collection coupling portion 62. According to this configuration, it is possible to supply the liquid collected in the liquid collection container 60 to the liquid container 18 smoothly. Also, for example, there may be a case where the collection coupling portion 62 can be used as an atmospheric vent.

### Fourth Embodiment

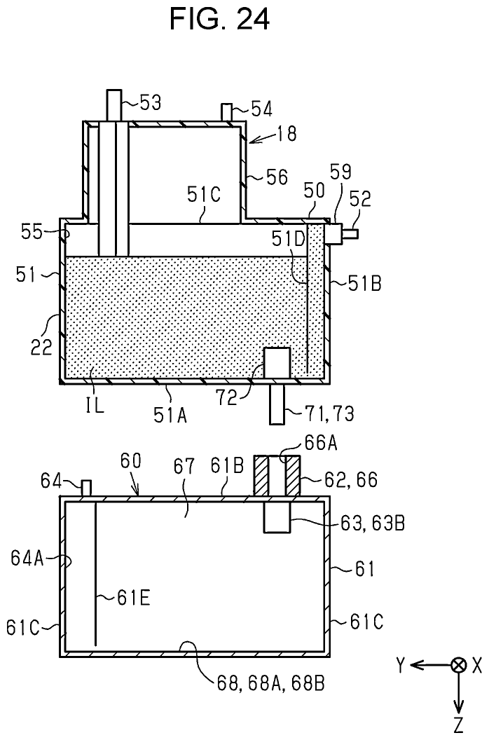

Next, a configuration of a collection container 60 of a fourth embodiment will be described with reference to FIGS. 24 to 26. The basic configuration of a liquid ejecting apparatus 11 is the same as the first embodiment. The configuration of a liquid container 18 is the same as the second and third embodiments. Hence, in the following, the configuration of the collection container 60 will mainly be described. Note that the liquid container 18 and the collection container 60 will be described by assigning the same reference numerals to configurations common to the second and third embodiments and omitting detailed descriptions.

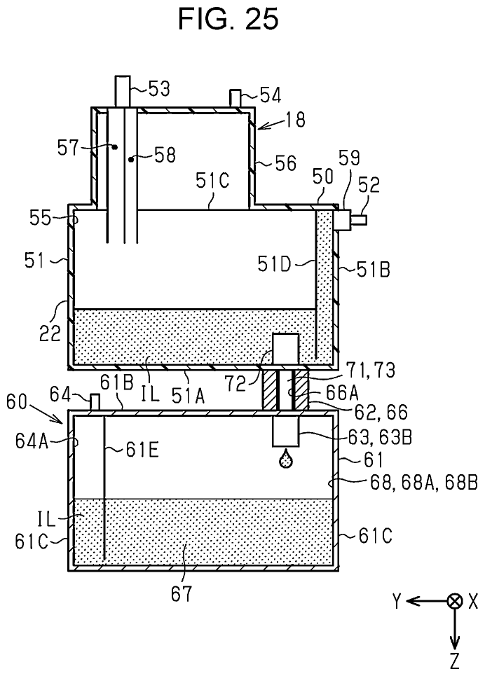

As illustrated in FIGS. 24 and 25, as in the third embodiment, the collection container 60 of the present embodiment includes a function of returning liquid collected from the liquid container 18 to the liquid container 18. In addition to the use of collecting residual liquid in the liquid container 18 at the time of disposal of the liquid ejecting apparatus 11, this function can be used when the liquid in the liquid container 18 needs to be discharged temporarily due to circumstances such as transport or maintenance of the liquid ejecting apparatus 11.

As illustrated in FIGS. 24 and 25, a plurality of collection coupling portions 62 is formed according to the number of the liquid containers 18, and the inside of the liquid collection container 60 is partitioned into the same number of spaces as the number of liquid containers 18. To be specific, as in the third embodiment, the collection container 60 is partitioned into a plurality of collection compartments 68 by a partition wall portion 67. In an upper surface 61B of the collection container 60, a plurality of collection coupling portions 62 respectively corresponding to the plurality of collection compartments 68 are provided in a protruding manner. The collection coupling portion 62 is formed of a cylinder portion 66 having a recessed shape having a recessed portion 66A that can be fitted into a pipe-shaped liquid discharge portion 71 having a protruding shape.

As in the embodiments described above, the collection container 60 of the present embodiment also includes the collection coupling portion 62, a collection container portion 61, and an atmospheric connection portion 64. The collection coupling portion 62 is provided with a sealing member 63 that prevents leakage of liquid through a passage of the collection coupling portion 62. The sealing member 63 is a sealing valve 63B capable of opening and closing the passage of the collection coupling portion 62, for example. The sealing valve 63B has the same configuration as the third embodiment, for example, and includes a valve body, an energizing member, and a valve seat. When the liquid discharge portion 71 is coupled to the collection coupling portion 62, the valve body is separated from the valve seat by a force received from the liquid discharge portion 71, whereby the sealing valve 63B is switched to the open-valve state from the closed-valve state. Moreover, when the liquid discharge portion 71 is removed from the collection coupling portion 62, the valve body comes into contact with the valve seat by the energizing force of the energizing member, so that the sealing valve 63B is switched to the closed-valve state from the open-valve state.

As illustrated in FIG. 25, the liquid discharge portion 71 of the liquid container 18 and the collection coupling portion 62 of the collection container 60 are coupled to each other. In this coupled state, the liquid in the liquid container 18 is moved by hydraulic head pressure and is collected in the collection container 60. Thus, after collection of the liquid, maintenance, transport, or the like of the liquid ejecting apparatus 11 is performed.

Moreover, the collection container 60 of the fourth embodiment has a liquid re-supply portion 81 capable of connecting to a liquid pouring portion 53. Note, however, that the dedicated liquid re-supply portion 81 provided in the collection container 60 of the third embodiment is not provided. The collection coupling portion 62 may also serve as the liquid re-supply portion 81.

Thus, since the collection coupling portion 62 also serves as the liquid re-supply portion 81 in the present embodiment, when returning the liquid in the collection container 60 to the liquid container 18, the collection container 60 is turned upside down with the collection coupling portion 62 facing downward. Then, the liquid re-supply portion 81 also serving as the collection coupling portion 62 is coupled to the liquid pouring portion 53 of the liquid container 18. When the collection container 60 is turned upside down, the atmospheric connection portion 64 is located on the lower side in a vertical direction Z. The collection container 60 is configured such that the atmospheric connection portion 64 is connected to the atmosphere even in such an upside-down position.

As illustrated in FIG. 24, the collection container 60 has, in the collection compartment 68, a passage forming partition wall portion 61E extending toward a bottom portion from an upper portion of the collection container portion 61. Inside the collection compartment 68, the passage forming partition wall portion 61E forms an atmospheric connection passage 64A connected to the atmospheric connection portion 64. Inside the collection compartment 68, the atmospheric connection passage 64A is connected to the space region other than the atmospheric connection passage 64A through a connection portion on a bottom portion side.

By providing such a passage forming partition wall portion 61E, it is possible to fill the atmospheric connection passage 64A with air even when the collection container 60 storing liquid is flipped upside down. As a result, the collection coupling portion 62 is also used as the liquid re-supply portion 81.

After maintenance, transport, or the like ends, the user returns the liquid in the collection container 60 to the liquid container 18. At this time, the collection container 60 containing liquid is flipped upside down by rotating it halfway clockwise in FIG. 25. In the process of the halfway rotation of the collection container 60, the liquid flows out of the atmospheric connection passage 64A and the atmospheric connection passage 64A is filled with air.

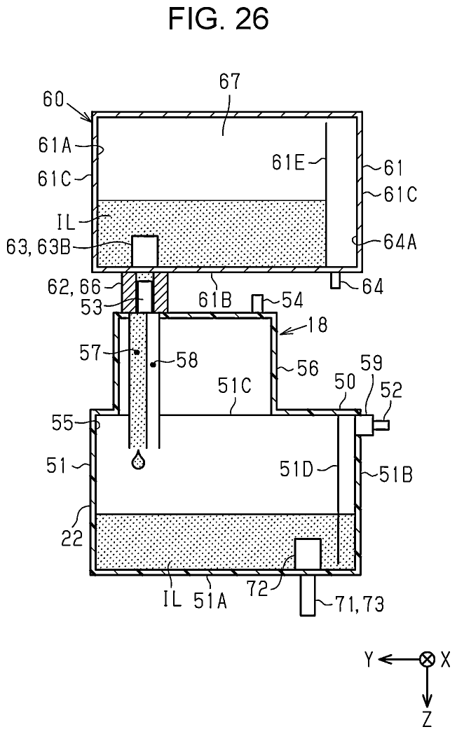

Then, as illustrated in FIG. 26, the collection coupling portion 62 of the collection container 60 is coupled to the liquid pouring portion 53 of the liquid container 18 in this upside-down position. Here, the inner diameter of the cylinder portion 66 forming the collection coupling portion 62 is a dimension that can fit the liquid pouring portion 53 on the liquid container 18 side. To be specific, since the liquid pouring portion 53 of the liquid container 18 is formed of a tube portion having a protruding shape, the collection coupling portion 62 is formed of a cylinder portion 66 having a recessed shape that can fit the protruding liquid pouring portion 53. Then, the inner diameter of the cylinder portion 66 is set to a dimension that can be externally fitted into the tube portion forming the liquid pouring portion 53.

When the collection coupling portion 62 and the liquid pouring portion 53 are coupled to each other in the state illustrated in FIG. 26, the liquid pouring portion 53 pushes a valve body (not illustrated) forming a sealing valve 63B against the energizing force of an energizing member, so that the sealing valve 63B is switched to the open-valve state from the closed-valve state. Therefore, the liquid in the collection container 60 passes through the liquid passage 57 and flows into the liquid container 18 by hydraulic head pressure.

At this time, with the entry of liquid into the liquid container 18, the air inside the liquid compartment 55 moves to the collection container 60 through an air passage 58. Thus, liquid in the collection container 60 continuously flows into the liquid container 18 while gas-liquid exchange is performed in the liquid container 18. Thus, the liquid in the collection container 60 is returned to the liquid container 18.

Therefore, according to the fourth embodiment, the effects of (1-1) to (1-4) and (1-7) to (1-10) of the first embodiment and the effects of (3-1) to (3-3) of the third embodiment can be obtained in the same manner, and the following effects can also be obtained.

(4-1) The collection coupling portion 62 also serves as the liquid re-supply portion 81. According to this configuration, since the collection coupling portion 62 of the collection container 60 also serves as the liquid re-supply portion 81, it is possible to reduce the complexity of the collection container 60 structure.

### Fifth Embodiment

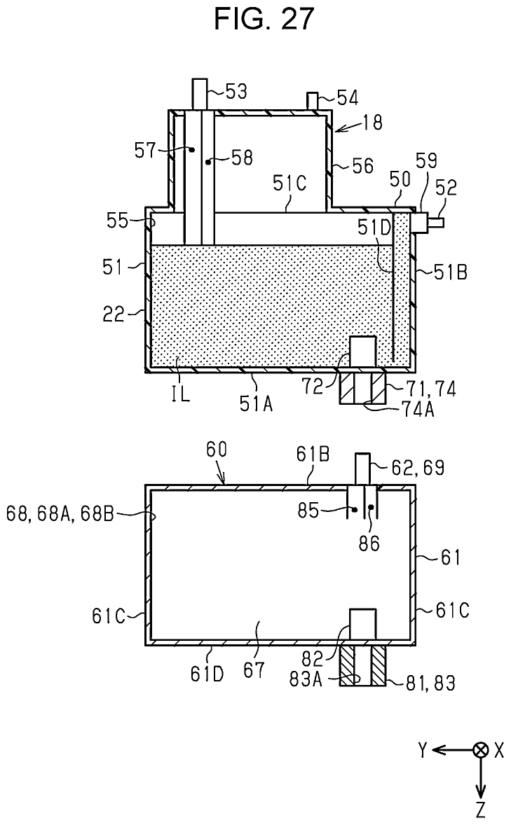

Next, a configuration of a collection container 60 of a fifth embodiment will be described with reference to FIGS. 27 to 29. The configuration of a liquid container 18 is the same as the second to fourth embodiments.

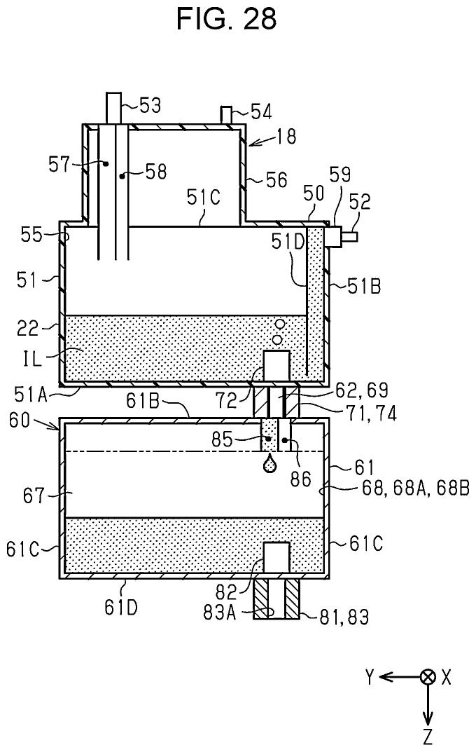

As illustrated in FIGS. 27 and 28, as in the third and fourth embodiments, the collection container 60 of the present embodiment has a function of returning liquid collected from the liquid container 18 to the liquid container 18. In addition to the use of collecting residual liquid in the liquid container 18 at the time of disposal of the liquid ejecting apparatus 11, this function can be used when the liquid in the liquid container 18 needs to be discharged temporarily due to circumstances such as transport or maintenance of the liquid ejecting apparatus 11.

As illustrated in FIG. 27, the liquid collection container 60 includes a collection container portion 61 and a collection coupling portion 62. The collection coupling portion 62 can be coupled to a liquid discharge portion 71 of the liquid container 18. The collection container portion 61 stores liquid collected from the liquid container 18 through the collection coupling portion 62 coupled to the liquid discharge portion 71. The collection container 60 does not include the atmospheric connection portion 64 provided in the collection container 60 of the first to fourth embodiments. The collection coupling portion 62 includes both a liquid passage 85 and an airflow passage 86 forming a gas-liquid exchange portion.

As illustrated in FIG. 27, in the collection container portion 61, a plurality of collection coupling portions 62 are formed according to the number of the liquid containers 18. The inside of the liquid collection container 60 is partitioned into the same number of spaces as the number of liquid containers 18. To be specific, the collection container 60 is partitioned into a plurality of collection compartments 68 by a partition wall portion 67. In an upper surface 61B of the collection container 60, a plurality of collection coupling portions 62 respectively corresponding to the plurality of collection compartments 68 are provided in a protruding manner. The collection coupling portion 62 is formed of a pipe portion 69 that can be fitted into the liquid discharge portion 71 formed of a tube portion 74 having a recessed shape. The pipe portion 69b can be inserted into a recessed portion 74A of the tube portion 74.

As illustrated in FIG. 27, the collection container 60 has a liquid re-supply portion 81 as a liquid supply port for returning the liquid collected in the collection container portion 61 to the liquid container 18. The liquid re-supply portion 81 can be coupled to the liquid pouring portion 53. The liquid re-supply portion 81 is provided in a lower portion opposite to an upper portion of the collection container portion 61 where the collection coupling portion 62 is formed. That is, the liquid re-supply portion 81 is provided in a bottom surface 61D of the collection container portion 61. Thus, the liquid re-supply portion 81 is formed separately from the collection coupling portion 62. Note that the liquid re-supply portion 81 is not limited to the bottom surface 61D of the collection container portion 61, and may be provided in a lower portion of a side surface 61C.

As illustrated in FIG. 27, the liquid re-supply portion 81 is formed of a tube portion 83. The tube portion 83 is formed with an inner diameter dimension that can be fitted into the liquid pouring portion 53 on the liquid container 18 side. To be specific, the liquid re-supply portion 81 is formed of the tube portion 83 having a recessed shape that can be fitted into the liquid pouring portion 53 having a protruding shape. The tube portion 83 is formed with an inner diameter dimension that can be externally fitted into the tube portion of the liquid pouring portion 53. Note that the protrusion-recess relationship between the liquid re-supply portion 81 and the liquid pouring portion 53 may be opposite.

The liquid passage 85 and the airflow passage 86 forming the gas-liquid exchange portion provided in the collection coupling portion 62 have the same basic principle as a liquid passage 57 and an air passage 58 forming a gas-liquid exchange portion provided in the liquid container 18. That is, as illustrated in FIG. 28, when the liquid discharge portion 71 of the liquid container 18 and the collection coupling portion 62 of collection container 60 are coupled to each other, the liquid is moved from the liquid container 18 to the collection container 60 by hydraulic head pressure. Air in the collection compartment 68 is discharged into the liquid container 18 through the airflow passage 86 until it reaches the liquid level indicated by the double-dashed line in the collection container 60 illustrated in FIG. 28. Air bubbles that emerge from the liquid discharge portion 71 in the liquid container 18 are discharged from the liquid compartment 55 through the air passage 58 and the liquid pouring portion 53 to the atmosphere.

On the other hand, if the liquid reaches the liquid level indicated by the double-dashed line in the collection container 60 illustrated in FIG. 28, the airflow passage 86 is closed with liquid. As a result, the movement of liquid from the liquid container 18 to the collection container 60 through the liquid passage 85 stops. Thus, in the collection container 60, the airflow passage 86 which forms the gas-liquid exchange portion integrally provided with the collection coupling portion 62 functions as a kind of atmospheric connection portion that indirectly connects to the atmosphere by a path through the liquid pouring portion 53 on the coupling-destination liquid container 18 side. In this respect, the liquid discharge portion 71 also serves as an atmospheric connection portion. Note that since the capacity of the collection container 60 is larger than the total liquid capacity of the corresponding liquid container 18, the liquid basically never reaches the liquid level indicated by the double-dashed line in FIG. 28.

When the liquid collection illustrated in FIG. 28 ends, maintenance, transport, or the like of the liquid ejecting apparatus 11 is performed. After maintenance, transport, or the like ends, the user returns the liquid in the collection container 60 to the liquid container 18.

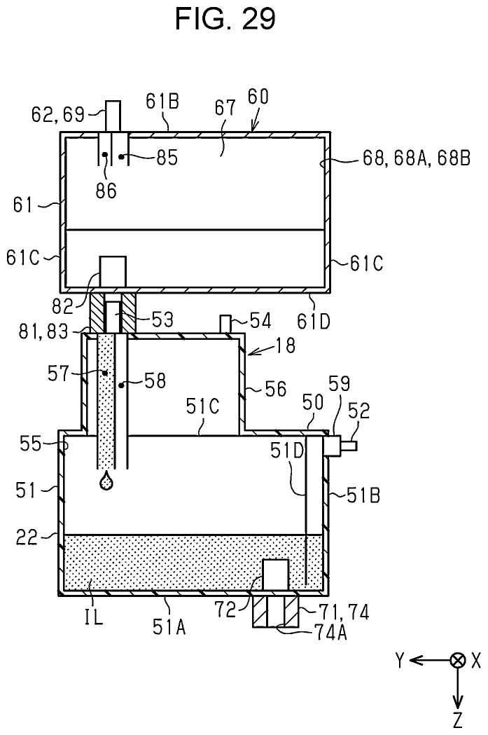

As illustrated in FIG. 29, the liquid re-supply portion 81 of the collection container 60 is coupled to the liquid pouring portion 53 of liquid container 18. At the time of this coupling, when the liquid pouring portion 53 pushes the valve body of the sealing valve 63B, the sealing valve 63B is switched to the open-valve state from the closed-valve state. As a result, the liquid in the collection container 60 moves to the liquid container 18 through the liquid passage 57 by hydraulic head pressure.

At this time, air in the liquid compartment 55 is discharged from the atmospheric connection portion 54 to the outside as the liquid flows into the liquid container 18. As a result, the liquid in the collection container 60 continuously moves into the liquid container 18. Air is also introduced into the collection compartment 68 from the collection coupling portion 62 as the liquid in the collection container 60 decreases. That is, the collection coupling portion 62 connects the atmosphere and the inside of the collection compartment 68, and therefore functions as an atmospheric connection portion. As a result, the liquid in the collection container 60 continuously moves to the liquid container 18. Thus, the liquid in the collection container 60 is returned to the liquid container 18.

Therefore, according to the fifth embodiment, the effects of (1-1) to (1-4) and (1-7) to (1-10) of the first embodiment and the effects of (3-1) and (3-2) of the third embodiment can be obtained in the same manner, and the following effects can also be obtained.

(5-1) The collection coupling portion 62 also serves as the atmospheric connection portion. According to this configuration, since the collection coupling portion 62 also functions as the atmospheric connection portion, it is possible to simplify the configuration of the liquid collection container 60.

Note that the above embodiments can also be modified into modes such as the modifications described below. Furthermore, the above embodiment and the following modification may be appropriately combined to obtain a different modification, or the following modifications may be appropriately combined to obtain a different modification.

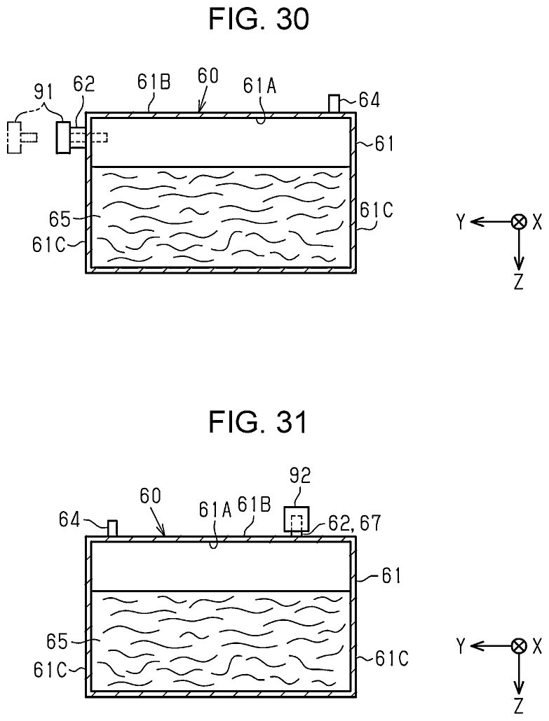

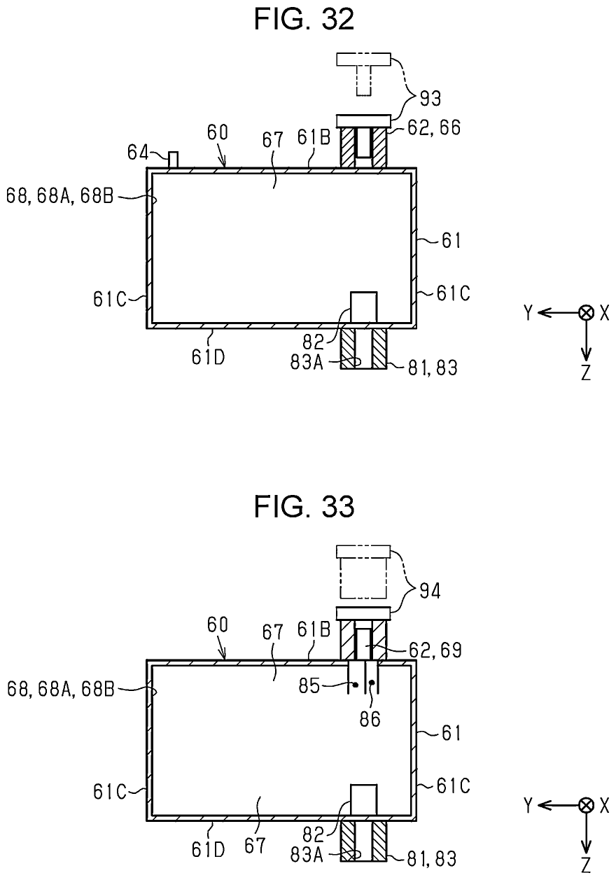

The collection container 60 may include a sealing member attached in a detachable manner to the collection coupling portion 62. For example, as illustrated in FIG. 30, the collection container 60 of the first embodiment may include an attachable and detachable sealing member 91 in the collection coupling portion 62. The sealing member 91 is a cap member sealing a coupling port of the collection coupling portion 62. The sealing member 91 is attached by being fitted or screwed into the collection coupling portion 62 so as to seal the coupling port, for example. When collecting liquid, the user removes the sealing member 91 from the collection coupling portion 62 and couples the liquid discharge portion 71 of the liquid container 18 to the collection coupling portion 62. When collection of liquid into the collection container 60 ends, the coupling between the liquid container 18 and the collection container 60 is released, and the sealing member 91 is attached to the collection coupling portion 62 of the collection container 60. According to this configuration, it is possible to curb leakage of liquid collected in the collection container 60 from the collection coupling portion 62. Moreover, as illustrated in FIG. 31, the collection container 60 of the second embodiment may include an attachable and detachable sealing member 92 in the collection coupling portion 62. Furthermore, as illustrated in FIG. 32, the collection container 60 of the third embodiment may include an attachable and detachable sealing member 93 in the collection coupling portion 62. In this case, as illustrated in FIG. 32, the sealing valve 63B may be omitted. Further, as illustrated in FIG. 33, the collection container 60 of the fifth embodiment may include an attachable and detachable sealing member 94 in the collection coupling portion 62. Alternatively, the collection container 60 of the fourth embodiment may include an attachable and detachable sealing member in the collection coupling portion 62. All of these configurations can curb leakage of liquid collected in the collection container 60 from the collection coupling portion 62. The collection container 60 of the third to fifth embodiments basically cannot accommodate the liquid holding member 65 that can contribute to liquid leakage control, but the sealing members 91 to 94 can curb leakage of liquid in the collection container 60.

The moving direction of the door body 19B can be set in any way as long as liquid container 18 can be taken out in the first direction A. For example, the sliding direction may be the width direction X. The door body 19B is not limited to the sliding type as long as the liquid container 18 can be taken out in the first direction A, and the door body 19B can also be a rotary type. For example, the door body 19B may be configured to rotate about the bottom end, rotate about the right end, rotate about the left end, or rotate about the top end.

While the above embodiments adopt the method of coupling the liquid container 18, which is removed from the casing 20 by releasing the fixing portions 42, to the collection container 60, a method of coupling the liquid collection container 60 to the liquid container 18 while the liquid container 18 is fixed to the casing 20 may also be adopted. For example, the liquid discharge portion 71 of the liquid container 18 is exposed through an opening in a bottom plate of the casing 20, and the collection coupling portion 62 of the collection container 60 is coupled to the liquid discharge portion 71 through the opening. The opening may be covered with a cover for embodiments other than the coupling embodiment. Otherwise, if the liquid discharge portion 71 is exposed from the casing 20, the position of the opening may be on another surface of the casing 20, such as a side surface of the casing 20. In short, even with the liquid container 18 fixed to the casing 20, the method only needs to include two steps of (a) coupling the liquid discharge portion 71 of the liquid container 18 to the collection coupling portion 62 of the liquid collection container 60, and (b) collecting the liquid in the liquid container 18 by moving it into the liquid collection container 60 by hydraulic head pressure. According to this liquid collection method, there is no need to release the fixing portions 42, and residual liquid in the liquid container 18 can be collected in the liquid collection container 60 without adopting a special structure necessary for removing the liquid container 18 from the storage portion 19, such as providing the door body 19B. Therefore, when the liquid ejecting apparatus 11 is disposed of with residual liquid in the liquid container 18, the environmental load caused by the leaked liquid can be curbed.

The first direction A, which is the moving direction of the liquid container 18 when removing it from the liquid ejecting apparatus 11, is not limited to the Y direction, and can be another direction. For example, the first direction A may be set to the +Z direction (downward) to remove the liquid container 18 from the bottom plate opening of the casing 20, or the first direction A may be set to the −Z direction (upward) to remove the liquid container 18 upward by opening the cover 32. The first direction A may be set to the −Y direction (backward) to remove the liquid container 18 from the back of the casing 20. Furthermore, the first direction A may be set to the −X direction (to the right) to remove the liquid container 18 to the right through an opening in a right side portion of the storage portion 19 with the door body open. In a configuration where the storage portion 19 is located to the left of the front portion of the casing 20, the liquid container 18 may be removed to the left through an opening in a left side portion of the storage portion 19 with the door body open.

The guide for removing the liquid container 18 from the casing 20 is not limited to the guide portion 48A such as a guide groove. For example, the guide portion may be a rail. The liquid container 18 may be guided by the rail to move in the first direction A. Alternatively, the liquid container 18 may be moved in the first direction A electrically. In this case, the power source motor may also serve as the drive source of a transport portion transporting the medium M, or the drive source of the maintenance device 35.

The connection portion 45 may be fixed by an arm extending from a frame forming the casing 20. For example, if a tube that forms the supply passage 24 is stretched in the process of moving the liquid container 18 in the first direction A, the force required for disconnection is likely to increase due to the restoring force of the stretched tube, and the impact of the tube shrinking at once when the coupling is disconnected may cause liquid such as ink to splash. In contrast, if the connection portion 45 is fixed directly or indirectly to the casing 20, the liquid container 18 can be disconnected from the supply passage 24 without stretching the tube when liquid container 18 is moved in the first direction A. Note that the portion of the supply passage 24 that extends at least a predetermined length on the one end portion side of the supply passage 24 may be made of a synthetic resin or metal tubing material to increase rigidity, thereby curbing stretching of the supply passage 24 when the liquid container 18 is removed.

The position of the liquid discharge portion 71 in the liquid storage portion 51 and the position of the collection coupling portion 62 in the collection container portion 61 may be changed as needed, as long as the liquid can be discharged by hydraulic head pressure.

In the first embodiment, the first valve 59 of the liquid supply portion 52 may be a manual opening and closing valve that can be manually opened and closed, or may have the function of a manual opening and closing valve. In this case, while the liquid supply portion 52 can be coupled to the collection container 60, when collecting liquid in another container such as an empty bottle, leakage can be curbed even when collecting liquid in another container if the valve can be opened by manual operation.

In the second to fifth embodiments, the second valve 72 of the liquid discharge portion 71 may be a manual opening and closing valve that is manually opened and closed, or an electrically operated opening and closing valve that also has the function of a manual opening and closing valve.

While the liquid ejecting apparatus 11 in the above embodiments includes a plurality of liquid containers 18, the liquid ejecting apparatus 11 may be an apparatus including only one liquid container 18. The liquid ejecting apparatus 11 may be configured such that one liquid container 18 stores black ink as a liquid, and the liquid ejecting apparatus 11 may be a printer dedicated to black and white printing.

The liquid holding member 65 is not limited to a non-woven fabric or a porous material, and may also be super absorbent polymer (SAP).

In the above embodiments, liquid is collected in the collection container 60 by connecting the liquid discharge portion 71 to the collection container portion 61. However, the liquid in the liquid container 18 may be poured from the liquid discharge portion 71 into the filler port of the collection container 60. For example, the opening of the collection container portion 61 may be formed larger than the opening of the liquid discharge portion 71, and liquid may be poured by hydraulic head pressure from a position where the openings are separated from each other.

The moving direction when removing the liquid container 18 from the casing 20 may be in a direction other than Y direction (forward) or Z direction (downward). In short, the method should be along the coupling direction of the liquid supply portion 52 and the supply passage 24. For example, the moving direction may be in the −Y direction (backward) or −Z direction (upward), or it may be in the width direction X. When the moving direction is the width direction X, it may be in the −X direction (right direction) or in the +X direction (left direction). The moving direction may also be a direction with components in each of the two directions of X and Y, or in each of the two directions of Y and Z, or in each of the two directions of X and Z, and so on. Furthermore, the moving direction may be a direction with components in each of the three directions of X, Y, and Z.

In the liquid ejecting apparatus 11, the position of the liquid container 18 is not limited to the front right side of the casing 20, and may be on the front left side of the casing 20, for example. The position of the liquid container 18 may also be at the side of the casing 20 or at the rear of the casing 20. In the above embodiment, the liquid container 18 was positioned at a location where the casing 20 partially protrudes outward (e.g., to the front), but it may be positioned at a location where the casing 20 does not protrude outward.

The liquid ejecting apparatus 11 is not limited to ink jet printers that print on paper, and may also be a textile printing device.

The medium M on which the liquid ejecting apparatus 11 ejects liquid is not limited to paper, fabric, or the like, and may also be a synthetic resin film, a laminated medium containing a synthetic resin layer and a metal layer, or a foil made of metal or aluminum foil, for example.

The liquid ejecting apparatus 11 may be a liquid ejecting apparatus that ejects liquids other than ink. The state of liquid ejected as minute droplets from the liquid ejecting apparatus includes granular, teardrop-shaped, and with thread-like tails. The liquid here is any material that can be ejected from the liquid ejecting apparatus. For example, a liquid may be in the state of a substance when it is in the liquid phase, and includes fluids such as high or low viscosity liquids, sols, gel waters, other inorganic solvents, organic solvents, solutions, liquid resins, and liquid metals (metal melts). Liquid includes not only liquid as a state of matter, but also particles of functional materials formed of solids such as pigments and metal particles dissolved, dispersed, or mixed in a solvent. Typical examples of liquids include inks and liquid crystals as described in the above embodiments. Here, ink includes general water-based and oil-based inks and various liquid compositions such as gel ink, hot-melt ink, and the like. Specific examples of the liquid ejecting apparatus include devices that eject liquids containing materials such as electrode materials and color materials in dispersion or dissolution for use in the manufacture of liquid crystal displays, electroluminescent (EL) displays, surface emitting displays, color filters, and the like. The liquid ejecting apparatus can be a device for ejecting bioorganic material used in biochip production, a device used as a precision pipette to eject liquid as a sample, a textile dyeing device, a micro dispenser, and the like. The liquid ejecting apparatus may be a device that ejects lubricant with pinpoint accuracy into precision machinery such as watches and cameras, or a device that ejects transparent resin liquid such as UV-cured resin onto a substrate to form micro hemispherical lenses (optical lenses) used for optical communication elements and other applications. The liquid ejecting apparatus may be a device that ejects an etching solution such as acid or alkali to etch substrates or the like.

Hereinafter, technical ideas understood from the above embodiments and modifications will be described together with their effects.

(A) A liquid ejecting system includes a liquid ejecting apparatus provided with an ejection head that ejects liquid and a liquid container capable of storing liquid supplied to the ejection head, and a liquid collection container, in which: the liquid container includes a liquid storage portion capable of storing liquid, a liquid pouring portion that pours liquid into the liquid storage portion, a liquid supply portion that supplies liquid to the ejection head, and a liquid discharge portion that discharges the liquid stored in the liquid storage portion to the outside; and the liquid collection container includes a collection coupling portion capable of coupling with the liquid discharge portion, and a collection container portion that stores liquid collected from the liquid container through coupling between the liquid discharge portion and the collection coupling portion.

According to this configuration, it is possible to collect residual liquid such as ink in the liquid container into the liquid collection container from the liquid container. Therefore, it is possible to reduce the load on the environment caused by liquid contamination due to residual liquid such as ink leaking from the liquid container when disposing of the liquid ejecting apparatus.

(B) In the liquid ejecting system described in (A), liquid in the liquid container may be moved by hydraulic head pressure of the liquid to collect the liquid in the liquid collection container.

According to this configuration, it is possible to more smoothly collect residual liquid in the liquid container into the liquid collection container by hydraulic head pressure without employing a complex configuration.

(C) In the liquid ejecting system described in (A) or (B), the capacity of liquid collectable by the liquid collection container may be larger than the entire capacity of liquid storable in the liquid container. According to this configuration, it is possible to collect the entire liquid in the liquid container with one collection container.

(D) In the liquid ejecting system described in any one of (A) to (C), the collection coupling portion may be provided with a sealing member that prevents leakage of liquid through a passage of the collection coupling portion. According to this configuration, it is possible to curb leakage of the collected liquid to the outside of the liquid collection container.

(E) In the liquid ejecting system described in any one of (A) to (D), a liquid holding member may be enclosed inside the liquid collection container. According to this configuration, it is possible to reduce the risk of the liquid collected in the liquid collection container being dispersed outside.

(F) In the liquid ejecting system described in any one of (A) to (E), the same number of collection coupling portions as the liquid containers or less may be provided, and the inside of the liquid collection container may be formed as one space as a whole. According to this configuration, since the liquid in the liquid containers can be collected in the liquid collection container altogether, it is possible to dispose of the collected liquid altogether.

(G) In the liquid ejecting system described in any one of (A) to (F), a plurality of collection coupling portions may be formed according to the number of the liquid containers, and the inside of the liquid collection container may be partitioned into the same number of spaces as the number of liquid containers. According to this configuration, it is possible to collect liquid in the liquid containers separately in spaces partitioned inside the liquid collection container. It is possible to prevent mixing of different liquids considering refilling of the liquids after collection.

(H) In the liquid ejecting system according to any one of (A) to (G), the liquid collection container may have a liquid re-supply portion that can be coupled to the liquid pouring portion. According to this configuration, it is possible to reuse liquid collected in the liquid collection container.

(I) In the liquid ejecting system according to any one of (A) to (H), the collection coupling portion may also serve as the liquid re-supply portion. According to this configuration, since the collection coupling portion of the liquid collection container also serves as the liquid re-supply portion, it is possible to reduce the complexity of the collection container structure.

(J) The liquid ejecting system described in any one of (A) to (H), the liquid re-supply portion may be formed separately from the collection coupling portion. According to this configuration, it is possible to supply the liquid collected in the liquid collection container to the liquid container smoothly. For example, there may be a case where the collection coupling portion can be used as an atmospheric vent.

(K) A liquid collection container includes a collection coupling portion capable of coupling with the liquid discharge portion of the liquid container, a collection container portion that stores liquid collected from the liquid container through the collection coupling portion coupled to the liquid discharge portion, and an atmospheric connection portion that connects the inside of the collection container portion to the atmosphere.

(L) In the liquid collection container described in (K), the collection coupling portion may also serve as the atmospheric connection portion. According to this configuration, since the collection coupling portion also functions as the atmospheric connection portion, it is possible to simplify the configuration of the liquid collection container.

(M) The liquid collection container described in (K) or (L) may include a sealing member that prevents leakage of liquid through a passage of the collection coupling portion. According to this configuration, since the sealing member that prevents leakage of liquid through the passage of the collection coupling portion is provided, it is possible to curb leakage of liquid in the liquid collection container from a discharge coupling portion after collection of the liquid.

(N) A liquid collection method of collecting liquid in the liquid container provided in the liquid ejecting apparatus in the liquid ejecting system described in any one of (A) to (M) includes: coupling the liquid discharge portion of the liquid container and the collection coupling portion of the liquid collection container to each other; and moving and collecting the liquid in the liquid container into the liquid collection container by hydraulic head pressure. According to this method, it is possible to collect residual liquid such as ink in the liquid container from the liquid container to the liquid collection container. Therefore, it is possible to reduce the load on the environment caused by liquid contamination due to leakage of residual liquid such as residual ink in the liquid container when disposing of the liquid ejecting apparatus.

(O) The liquid collection method described in (N) may further include removing the liquid container from the liquid ejecting apparatus before coupling the liquid discharge portion and the collection coupling portion to each other. According to this method, the liquid container is removed from the liquid ejecting apparatus before coupling the liquid discharge portion and the collection coupling portion to each other. Therefore, it is possible to couple the liquid discharge portion and the collection coupling portion to each other more easily as compared to a method of coupling the liquid discharge portion and the collection coupling portion to each other without removing the liquid container from the liquid ejecting apparatus.

What is claimed is:

1. A liquid ejecting system comprising
a liquid ejecting apparatus provided with an ejection head that ejects liquid and a liquid container configured to store liquid supplied to the ejection head, and a liquid collection container, wherein:
the liquid container includes
a liquid storage portion configured to store liquid,
a liquid pouring portion that pours liquid into the liquid storage portion,
a liquid supply portion that supplies liquid to the ejection head, and
a liquid discharge portion that discharges the liquid stored in the liquid storage portion to the outside; and
the liquid collection container includes
a collection coupling portion configured to be coupled to the liquid discharge portion, and
a collection container portion that stores liquid collected from the liquid container through coupling between the liquid discharge portion and the collection coupling portion.

2. The liquid ejecting system according to claim 1, wherein liquid in the liquid container is moved by hydraulic head pressure of the liquid to collect the liquid in the liquid collection container.

3. The liquid ejecting system according to claim 1, wherein
a capacity of liquid collectable by the liquid collection container is larger than an entire capacity of liquid storable in the liquid container.

4. The liquid ejecting system according to claim 1, wherein
the collection coupling portion is provided with a sealing member that prevents leakage of liquid through a passage of the collection coupling portion.

5. The liquid ejecting system according to claim 1, wherein
a liquid holding member is enclosed inside the liquid collection container.

6. The liquid ejecting system according to claim 1, wherein
the same number of collection coupling portions as the liquid containers or less is provided, and the inside of the liquid collection container is formed as one space as a whole.

7. The liquid ejecting system according to claim 1, wherein
a plurality of collection coupling portions are formed according to the number of the liquid containers, and
the inside of the liquid collection container is partitioned into the same number of spaces as the number of liquid containers.

8. The liquid ejecting system according to claim 1, wherein
the liquid collection container has a liquid re-supply portion configured to be coupled to the liquid pouring portion.

9. The liquid ejecting system according to claim 8, wherein
the collection coupling portion also serves as the liquid re-supply portion.

10. The liquid ejecting system according to claim 8, wherein
the liquid re-supply portion is formed separately from the collection coupling portion.

11. A liquid collection container in the liquid ejecting system according to claim 1, the liquid collection container comprising:
a collection coupling portion configured to be coupled to the liquid discharge portion of the liquid container;
a collection container portion that stores liquid collected from the liquid container through the collection coupling portion coupled to the liquid discharge portion; and
an atmospheric connection portion that connects the inside of the collection container portion to the atmosphere.

12. The liquid collection container according to claim 11, wherein
the collection coupling portion also serves as the atmospheric connection portion.

13. The liquid collection container according to claim 11, further comprising
a sealing member that prevents leakage of liquid through a passage of the collection coupling portion.

14. A liquid collection method of collecting liquid in the liquid container provided in the liquid ejecting apparatus in the liquid ejecting system according to claim 1, the method comprising: coupling the liquid discharge portion of the liquid container and the collection coupling portion of the liquid collection container to each other; and
moving and collecting the liquid in the liquid container into the liquid collection container by hydraulic head pressure.

15. The liquid collection method according to claim 14, further comprising
removing the liquid container from the liquid ejecting apparatus before coupling the liquid discharge portion and the collection coupling portion to each other.
